(19) United States
(12) Patent Application Publication
(10) Pub. No.: US 2012/0327055 A1
(43) Pub. Date: Dec. 27, 2012

(54) DISPLAY APPARATUS, AND DRIVE CONTROL METHOD FOR DISPLAY DEVICE

(75) Inventor: Masaki NOSE, Ebina (JP)

(73) Assignee: FUJITSU LIMITED, Kawasaki-shi (JP)

(21) Appl. No.: 13/473,951

(22) Filed: May 17, 2012

(30) Foreign Application Priority Data
Jun. 21, 2011 (JP) 2011-137683

(51) Int. Cl. G09G 5/00

(52) U.S. Cl. 345/211; 345/204

(57) ABSTRACT

A display apparatus includes a display device that has a memory property to maintain its display state even after a drive applied to the display device is removed; a detection circuit configured to detect a capacitance exhibited by the display device; an adjustment circuit configured to make an adjustment of a driving condition for the display device, based on the capacitance of the display device detected by the detection circuit when the display device is in a display state that is set by driving the display device under a predetermined driving condition; and a storing circuit configured to store a capacitance of the display device and a driving condition for the display device that are used in a previous adjustment, wherein the adjustment circuit changes an adjustment sequence in accordance with a difference between the capacitance detected by the detection circuit, and the capacitance stored in the storing circuit.

### CROSS-REFERENCE TO RELATED APPLICATION(S)

This application is based upon and claims the benefit of priority of the prior Japanese Patent Application No. 2011-137683, filed on Jun. 21, 2011, the entire contents of which are incorporated herein by reference.

### FIELD

The embodiments discussed herein are related to a display apparatus and a drive control method for a display device.

### BACKGROUND

Display apparatuses using a material having memory property such as a cholesteric liquid crystal have been developed and applied to electronic paper and so on. Electronic paper is manufactured by highly complicated manufacturing processes using a film substrate. Therefore, lot-to-lot variability tends to occur in the contrast, brightness, gamma characteristics, or the like of the display device. In addition, after manufacture, the contrast, brightness, or gamma characteristics of the display device may undergo changes after prolonged use. If such variability or aging occurs, it may become difficult for the display device to produce a desirable display even when driven under the same driving conditions.

Accordingly, it has been proposed to detect lot-to-lot variability or aging of the display device, and make an automatic adjustment to provide optimal driving conditions.

For example, it has been proposed to mount a luminance sensor to the display device, and detect the actual state of display to thereby make an adjustment to obtain a desired display state. However, mounting a luminance sensor to the display device is problematic from the viewpoints of cost and appearance. It is particularly undesirable to mount a luminance sensor to a reflective display device such as electronic paper whose major feature is its easy portability.

It is also common to measure the cumulative energization time of the display device that is continuously energized during display, thereby predicting its aging to make an appropriate compensation. However, electronic paper is energized only when rewriting, and the energization itself is performed irregularly. For this reason, it is not possible to apply a compensation based on cumulative energization time to electronic paper.

Driving a liquid crystal display device means driving each individual pixel having capacitance. The driving conditions are determined in accordance with the capacitance value. Accordingly, it has been proposed to provide dummy pixels, and detect the capacitance value of the dummy pixels to thereby adjust driving voltage. However, this method has a problem in that the capacitance of the dummy pixels and the capacitance of the actual display pixels do not match owing to their different drive histories, resulting in insufficient detection accuracy. Moreover, in the method of providing dummy pixels and detecting the capacitance value of the dummy pixels to thereby adjust driving voltage, the capacitance value is detected by detecting the oscillating frequency of a CR oscillation circuit formed by the dummy pixels. This detection method is practical for display devices with high resistivity and stable capacitance characteristics, such as TFT liquid crystal display devices. However, in the case of display devices with relatively low resistivity and unstable capacitance characteristics, such as cholesteric liquid crystals with memory property used for electronic paper, the stability of the oscillating circuit is not sufficient, making it difficult to detect capacitance with high accuracy.

It is recognized that the capacitance of a liquid crystal display device varies with temperature. In other words, the capacitance varies with temperature, and driving conditions also vary as a result. Accordingly, it has been proposed to adjust driving conditions by detecting the capacitance of the liquid crystal display device, thereby making it possible to obtain a good display at all times irrespective of temperature. However, to adjust driving conditions by detecting the capacitance of a liquid crystal display device is to make an adjustment according to temperature. Hence, no consideration is given to variability and aging.

As related art, for example, Japanese Laid-open Patent Publication No. 2008-065058, Japanese Laid-open Patent Publication No. 52-140295, and the like have been disclosed.

### SUMMARY

According to an aspect of the invention, a display apparatus includes a display device that has a memory property to maintain its display state even after a drive applied to the display device is removed; a detection circuit configured to detect a capacitance exhibited by the display device; an adjustment circuit configured to make an adjustment of a driving condition for the display device, based on the capacitance of the display device detected by the detection circuit when the display device is in a display state that is set by driving the display device under a predetermined driving condition; and a storing circuit configured to store a capacitance of the display device and a driving condition for the display device that are used in a previous adjustment, wherein the adjustment circuit changes an adjustment sequence in accordance with a difference between the capacitance detected by the detection circuit, and the capacitance stored in the storing circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the schematic configuration of a display apparatus according to a first embodiment;

FIG. 2 illustrates the configuration of a display device used in the display apparatus according to the first embodiment;

FIG. 3 illustrates the basic configuration of a single panel;

FIGS. 4A and 4B illustrate states of a cholesteric liquid crystal;

FIG. 5 illustrates an example of the voltage-reflection characteristic of a typical cholesteric liquid crystal;

FIG. 6 illustrates a drive waveform in the dynamic driving scheme (DDS);

FIG. 7 illustrates drive waveforms outputted by a common driver and a segment driver in accordance with the first embodiment;

FIG. 8 illustrates a voltage waveform applied to each pixel in accordance with the first embodiment;

FIG. 9 illustrates measurements on the relationship between brightness (reflectance) of a cholesteric liquid crystal and capacitance, with respect to five samples of a display device;

FIG. 10 illustrates the frequency characteristics of the capacitance of a display device;

FIG. 11 illustrates the configuration of a circuit portion that outputs a capacitance detection signal in a power supply unit, a current sense amplifier, and a computing unit;

FIG. 12 illustrates the waveform of a capacitance detection signal;

FIGS. 13A and 13B illustrate the results of an experiment in which a test cell of a cholesteric liquid crystal is used to detect capacitance;

FIG. 14 illustrates capacitance variation of a display device with varying evolution voltage in a case where the display device is driven by the DDS while setting the duty ratio of a selection pulse to a predetermined value;

FIGS. 15A and 15B illustrate a method of adjusting driving conditions in the display apparatus according to the first embodiment;

FIG. 16 is a flowchart illustrating an automatic adjustment process for driving conditions in the display apparatus according to the first embodiment;

FIGS. 17A and 17B illustrate examples of drive waveforms for setting a white display state or a black display state, respectively;

FIGS. 18A and 18B illustrate a method of adjusting the evolution voltage by the Newton's method so that a measured capacitance value becomes a target capacitance value;

FIG. 19 illustrates variation of the evolution voltage in a case where the Newton's method is applied for each of capacitances at the 10% and 90% points;

FIGS. 20A to 20C illustrate a method of adjusting the evolution voltage by the bisection method so that a measured capacitance value becomes a target capacitance value;

FIG. 21 illustrates an adjustment in a third step;

FIG. 22 illustrates the processing in a case where the third step is performed by using the bisection method;

FIG. 23 illustrates variation of duty ratio in a case where the bisection method is applied to determine the duty ratio that provides a capacitance at the 60% point;

FIG. 24 is a flowchart illustrating an automatic adjustment process for driving conditions with reduced processing time;

FIG. 25 illustrates a method of adjusting the evolution voltage or the duty ratio by the bisection method, in the automatic adjustment process for driving conditions with reduced processing time;

FIG. 26 illustrates a method of adjusting the evolution voltage or the duty ratio by the bisection method, in the automatic adjustment process for driving conditions with reduced processing time;

FIGS. 27A and 27B illustrate a method of setting a plurality of regions of a display screen into different display states, and measuring capacitance in each of the display states;

FIGS. 28A to 28D illustrate a method of measuring capacitances in a number of different display states by setting a plurality of regions of a display screen into different display states;

FIG. 29 illustrates the correspondence between the output voltages of a segment driver and common driver in the case of using a bipolar driver IC;

FIG. 30 is a flowchart illustrating an automatic adjustment process for driving conditions in a display apparatus according to a second embodiment;

FIG. 31 illustrates changes in the display state of a display apparatus according to a third embodiment;

FIGS. 32A and 32B illustrate a reset pulse and a write pulse with varying pulse width, respectively, according to the third embodiment; and

FIGS. 33A to 33D illustrate an example of a plurality of write pulses in a case where the write pulse application time is varied by the number of pulse applications in accordance with the third embodiment.

### DESCRIPTION OF EMBODIMENTS

Hereinafter, embodiments are described with reference to the drawings.

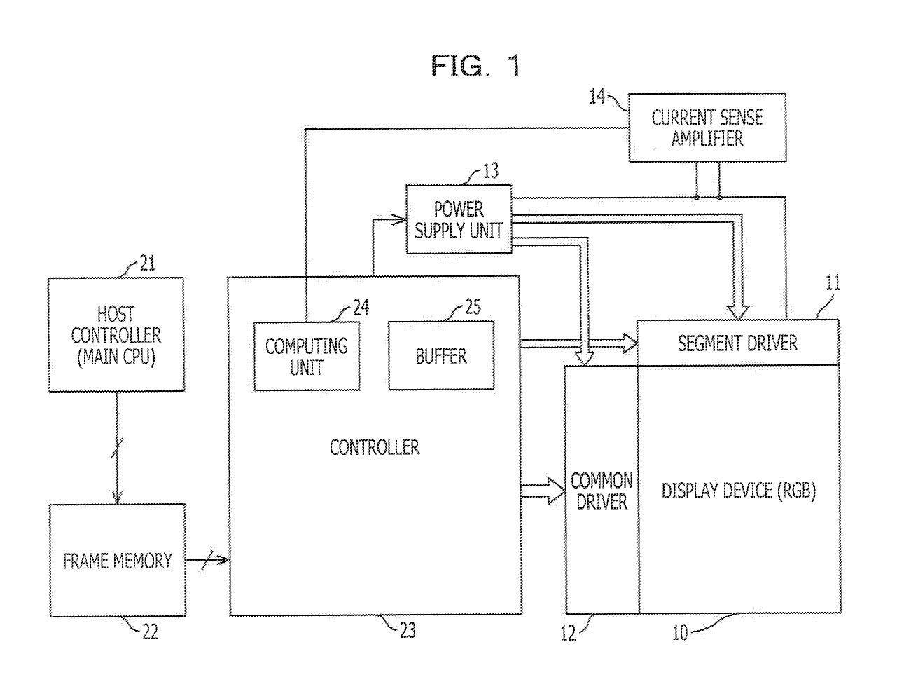

FIG. 1 illustrates the schematic configuration of a display apparatus according to a first embodiment. The display apparatus according to the first embodiment is electronic paper. A driving signal is applied to a display device 10 only when rewriting display. Once rewritten, the display is maintained with no applied driving signal.

As illustrated in FIG. 1, the display apparatus according to the first embodiment includes the display device 10 using a cholesteric liquid crystal, a segment driver 11, a common driver 12, a power supply unit 13, a current sense amplifier 14, a host controller 21, a frame memory 22, and a controller 23.

The host controller 21 includes a main CPU or the like. The host controller 21 applies various kinds of processing to image data stored in an external storage or image data acquired via a communication circuit or the like, thereby converting the image data into an image suitable for display on the display apparatus. For example, in order to display gray scale image data, the image data is gray-level transformed by using an existing gray level transformation method such as the error diffusion method, the ordered dither method, or the blue noise mask method, in conformity to the number of levels of gray that can be displayed on the display apparatus. In some cases, part of this processing is performed by the controller 23. The host controller 21 stores the generated image data into the frame memory 22.

The controller 23 includes a sub-CPU, a micro-computer, a PLD, or the like. The controller 23 controls various units other than the host controller 21. The controller 23 generates drive data in accordance with image data read from the frame memory 22, and supplies the generated drive data to the segment driver 11 and the common driver 12. Desirably, the controller 23 has a buffer 25 that temporarily stores generated drive data in order to facilitate adjustment of the supply timing of drive data to the segment driver 11 and the common driver 12.

The display device 10 uses a cholesteric liquid crystal. The display device 10 is capable of color display and made from three RGB panels that are stacked in layers. Details about the display device 10 are described later. The segment driver 11 and the common driver 12 drive the display device 10 by a passive matrix addressing, and are each implemented by a general-purpose driver IC. In this example, while the segment driver 11 includes three drivers and drives each of the layers of panels independently, it is possible for the common driver 12 to drive the three layers of panels commonly by a single driver.

In the power supply unit 13, a step-up regulator such as a DC-DC converter raises a voltage of 3V to 5 V supplied from a common power supply (not illustrated) of the display apparatus to about −25 V to +25 V. When raising the voltage, +50 V and a negative DC-DC converter are also used in combination in the case of a unipolar driver IC and in the case of a negative DC-DC converter, respectively. Of course, it is desirable to use a step-up regulator that provides high conversion efficiency with respect to the characteristics of the display device 10. Desirably, switching of reset and write voltages is performed by using an analog switch, a digital potentiometer, or the like. A booster circuit formed by an operational amplifier or transistor, and a smoothing capacitor may be placed downstream of this switching circuit for the purpose of stabilizing the driving voltage of the display device 10.

The configuration described above is substantially the same as that of typical display apparatus using a cholesteric liquid crystal, and it is possible to employ various existing configurations. The display device 10 is not limited to the display device 10 using a cholesteric liquid crystal but may be any display device 10 having memory property.

In the display apparatus according to the first embodiment, the power supply unit 13 generates a capacitance detection signal in the form of a sawtooth wave signal, a triangular wave signal, or the like in accordance with a control signal from the controller 23. The power supply unit 13 supplies the capacitance detection signal to the power supply terminal of the segment driver 11. Preferably, a portion not used for writing or the like is used as this power supply terminal. The power supply unit 13 can adjust the voltage supplied to each of the segment driver 11 and the common driver 12, in accordance with a control signal from the controller 23.

In the display apparatus according to the first embodiment, further, the current sense amplifier 14 is placed so as to detect the current in the signal line that supplies a capacitance detection signal from the power supply unit 13 to the segment driver 11. The current detected upon application of a capacitance detection signal to the display device 10 is related to the capacitance of the display device 10. The current sense amplifier 14 outputs the resulting detection signal to the computing unit 24.

The controller 23 executes a driving condition adjustment mode upon activation of the display apparatus or upon instruction from the user. The driving condition adjustment mode is automatically executed at all times when the display apparatus is used for the first time, such as at the time of product shipment. Thereafter, the driving condition adjustment mode may be automatically executed periodically, for example, about once every month. The controller 23 controls the power supply unit 13 to apply a capacitance detection signal to the display device 10, after setting the display device 10 into a predetermined display state. Then, the controller 23 controls the computing unit 24 to digitize a detection signal from the current sense amplifier 14 and capture the resulting signal as detection data. The computing unit 24 acquires the detection data while changing the display state of the display device 10 in accordance with a driving condition adjustment sequence described later, and determines the driving conditions that enable a desired display. After finishing the driving condition adjustment mode, the controller 23 controls various units in accordance with the determined driving conditions.

Next, a display apparatus using a cholesteric liquid crystal used as the display device 10 in the display apparatus according to the first embodiment is described.

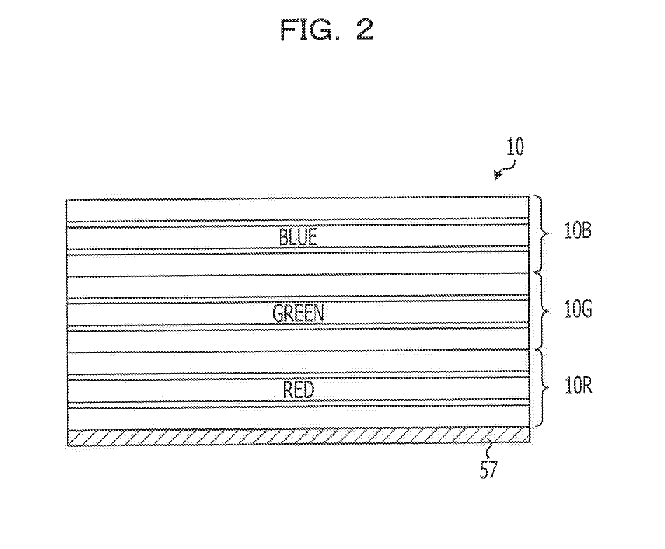

Next, FIG. 2 illustrates the configuration of the display device 10 used in the display apparatus according to the first embodiment. As illustrated in FIG. 2, the display device 10 has three panels, a panel 10B for blue, a panel 10G for green, and a panel 10R for red, which are stacked in this order from the side from which the display device 10 is to be viewed. A light absorption layer 57 is provided under the panel 10R for red. The panels 10B, 10G, and 10R have substantially the same configuration. However, the liquid crystal material and the chiral material are selected and the percentage content of the chiral material are determined so that the central wavelength of reflection of the panel 10B is blue (about 480 nm), the central wavelength of reflection of the panel 10G is green (about 550 nm), and the central wavelength of reflection of the panel 10R is red (about 630 nm). The scan electrodes and data electrodes of the panels 10B, 10G, and 10R are driven by the common driver 12 and the segment driver 11.

The panels 10B, 10G, and 10R have substantially the same configuration except for that their central wavelengths of reflection differ. Hereinafter, an example of the panels 10B, 10G, and 10R is represented by a panel 10A, and its configuration is described.

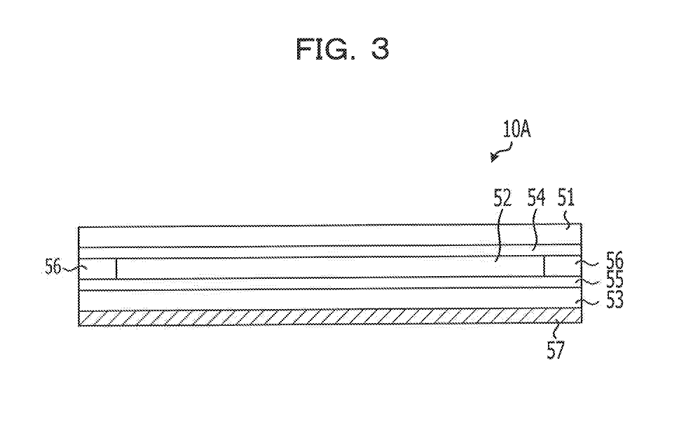

FIG. 3 illustrates the basic configuration of a single panel 10A.

As illustrated in FIG. 3, the panel 10A includes an upper substrate 51, an upper electrode layer 54 provided on the surface of the upper substrate 51, a lower substrate 53, a lower electrode layer 55 provided on the surface of the lower substrate 53, and a sealant 56. The upper substrate 51 and the lower substrate 53 are placed with their electrodes facing each other, and after a liquid crystal material is filled in between the electrodes, the resulting structure is sealed with the sealant 56. Although not illustrated, a spacer is placed inside a liquid crystal layer 52. A voltage pulse signal is applied to each of the electrodes of the upper electrode layer 54 and lower electrode layer 55, thereby applying a voltage to the liquid crystal layer 52. Display is produced by applying a voltage to the liquid crystal layer 52 to drive the liquid crystal molecules in the liquid crystal layer 52 into a planar state or a focal conic state. A plurality of scan electrodes and a plurality of data electrodes are formed in the upper electrode layer 54 and the lower electrode layer 55.

While the upper substrate 51 and the lower substrate 53 both have translucency, the lower substrate 53 of the panel 10R may be opaque. An example of a substrate having translucency is a glass substrate. Other than a glass substrate, a film substrate such as a polyethylene terephthalate (PET) or polycarbonate (PC) substrate can be also used.

A typical example of material used for the electrodes of the upper and lower electrode layers 54 and 55 is an indium tin oxide (ITO). Alternatively, it is also possible to use a transparent conductive coating such as an indium zinc oxide.

The transparent electrodes of the upper electrode layer 54 are formed on the upper substrate 51 as a plurality of strip-shaped upper transparent electrodes that are parallel to each other. The transparent electrodes of the lower electrode layer 55 are formed on the lower substrate 53 as a plurality of strip-shaped lower transparent electrodes that are parallel to each other. The upper substrate 51 and the lower substrate 53 are placed in such a way that the upper and lower electrodes intersect, and a pixel is formed at each intersection. An insulating thin film is formed on each of the electrodes. If the thin film is thick, a high driving voltage is to be applied. Conversely, if there is no thin film, a leak current flows, which reduces the accuracy of automatic adjustment according to the embodiments. In this example, the dielectric constant of the thin film is about 5, which is considerably lower than that of the liquid crystal. Accordingly, an appropriate thickness of the thin film is about 0.3 μm or less.

This insulating thin film can be implemented by a thin film of SiO₂, or an organic film of polyimide resin, acryl resin, or the like commonly used as an orientation stabilizing film.

As mentioned above, a spacer is placed inside the liquid crystal layer 52. The spacer makes the separation between the upper substrate 51 and the lower substrate 53, that is, the thickness of the liquid crystal layer 52 uniform. While a spacer is generally a sphere made of resin or inorganic oxide, it is also possible to use an adhered spacer obtained by coating the substrate surface with thermoplastic resin. An appropriate range of the cell gap formed by this spacer is 4 μm to 6 μm. If the cell gap is smaller than this value, reflectance decreases and the display becomes dark, and high threshold sharpness may not be expected. Conversely, if the cell gap is greater than this value, although high threshold sharpness can be maintained, the driving voltage increases, which makes driving by general-purpose components difficult.

The liquid crystal composition forming the liquid crystal layer 52 is a cholesteric liquid crystal with a 10 to 40 weight percent (wt %) of chiral material added to a nematic liquid crystal mixture. The amount of the chiral material added represents a value when the total amount of the nematic liquid crystal component and the chiral material is taken as 100 wt %.

While various existing nematic liquid crystals may be used as the nematic liquid crystal, it is desirable to use a nematic liquid crystal with a dielectric anisotropy (Δ∈) that falls within the range of 15 to 35. When the dielectric anisotropy is 15 or less, the driving voltage becomes generally higher, making it difficult to use general-purpose components for the driving circuit.

On the other hand, a dielectric anisotropy of 25 or more reduces threshold sharpness and may even reduce the reliability of the liquid crystal material itself.

Moreover, the refractive index anisotropy (Δn) of the liquid crystal material is desirably within the range of 0.18 to 0.24. A refractive index anisotropy below this range causes a decrease in reflectance in the planar state. On the other hand, a refractive index anisotropy exceeding this range causes, in addition to increased scatter reflections in the focal conic state, higher viscosity and lower response speed.

Next, bright/dark (white/black) display in the display apparatus using a cholesteric liquid crystal material is described. The display apparatus using a cholesteric liquid crystal controls display on the basis of the orientation state of liquid crystal molecules.

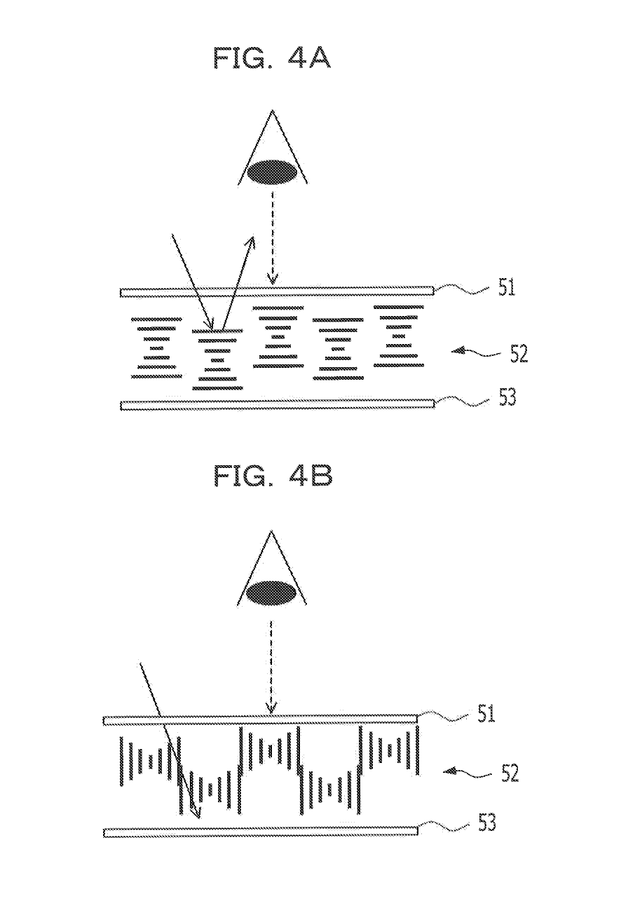

FIGS. 4A and 4B illustrate states of a cholesteric liquid crystal. A cholesteric liquid crystal has a planar state as illustrated in FIG. 4A in which incident light is reflected, and a focal conic state illustrated in FIG. 4B in which incident light is transmitted. These states are stably maintained even under no applied electric field. Other than these states, the cholesteric liquid crystal also assumes a homeotropic state upon application of a strong electric field, in which the liquid crystal molecules all align in the direction of the electric field. When application of the electric field is stopped, the homeotropic state changes to either the planar state or the focal conic state.

In the planar state, the cholesteric liquid crystal reflects light of wavelengths corresponding to the helical pitch of the liquid crystal molecules. The wavelength λ at which the maximum reflection occurs is expressed by the following equation, where n and p represent the mean refractive index and the helical pitch, respectively, of the liquid crystal:

λ=n·p

On the other hand, the reflection bandwidth Δλ, increases with increase in the refractive index anisotropy Δn of the liquid crystal.

In the planar state, incident light is reflected, resulting in a “bright” state, that is, it is possible to display white. On the other hand, in the focal conic state, light transmitted through the liquid crystal layer is absorbed by the light absorption layer 57 provided under the lower substrate 53, resulting in a “dark” state, that is, it is possible to display black. In a mixed state of the planar state and the focal conic state, the liquid crystal assumes an intermediate gray scale state between the “bright” state (white display) and the “dark” state (black display), with the precise gray scale level being determined by the mixing ratio between the planar state and the focal conic state.

Next, a method of driving the display device 10 using a cholesteric liquid crystal is described.

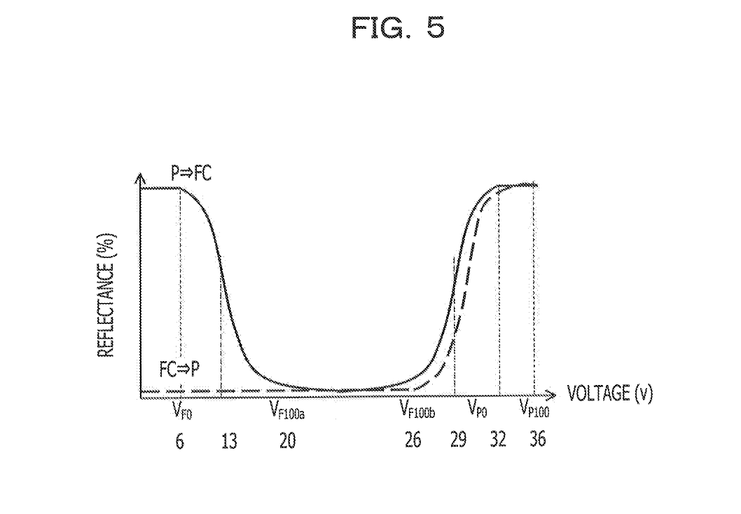

FIG. 5 illustrates an example of the voltage-reflectance characteristic of a typical cholesteric liquid crystal. The horizontal axis represents the voltage value (V) of a pulse voltage with a predetermined pulse width which is applied across the electrodes sandwiching the cholesteric liquid crystal. The vertical axis represents the reflectance (%) of the cholesteric liquid crystal. The solid curve P in FIG. 5 indicates the voltage-reflectance characteristic with the cholesteric liquid crystal initially in the planar state. The dashed curve FC represents the voltage-reflectance characteristic with the cholesteric liquid crystal initially in the focal conic state.

Upon generating a strong electric field (VP100 or more) in the cholesteric liquid crystal, while the electric field is applied, the helical structure of the liquid crystal molecules is completely untwisted, driving the cholesteric liquid crystal into the homeotropic state in which the molecules all align in the direction of the electric field. Next, when the liquid crystal molecules are in the homeotropic state, rapidly reducing the applied voltage from VP100 to substantially zero causes the helical axis of the liquid crystal to become perpendicular to the electrodes, driving the cholesteric liquid crystal into the planar state that selectively reflects light of wavelengths corresponding to the helical pitch.

On the other hand, when a weak electric field (within the range of VF100a to VF100b) that does not completely untwist the helical structure of the cholesteric liquid crystal molecules is applied and then the electric field is removed, or when a strong electric field is applied and then the electric field is gradually removed, the helical axis of the cholesteric liquid crystal molecules becomes parallel to the electrodes, driving the cholesteric liquid crystal into the focal conic state that transmits incident light.

Applying a medium electric field (VF0 to VF100a or VF100b to VP0) and then rapidly removing the electric field results in a mixed state of the planar state and the focal conic state, enabling display of a gray scale image.

Display is produced by exploiting the above-mentioned phenomena.

In the case of a passive matrix display apparatus using a cholesteric liquid crystal, a dynamic driving scheme (DDS) is used when rewriting at high speed. The display apparatus according to the first embodiment also displays a gray scale image by the DDS. A reset operation may be performed to drive all pixels into the planar state simultaneously prior to rewriting an image. The reset operation is done by forcibly setting all the outputs of each of the segment driver 11 and the common driver 12 to a predetermined voltage value. Since no transfer of data for setting an output value takes place, the reset operation can be executed in a short time. Since such a reset operation consumes electric power, the reset operation may not be performed for apparatus with low power consumption.

For the simplicity of explanation, a description is first given of a case where a binary image of white and black is displayed.

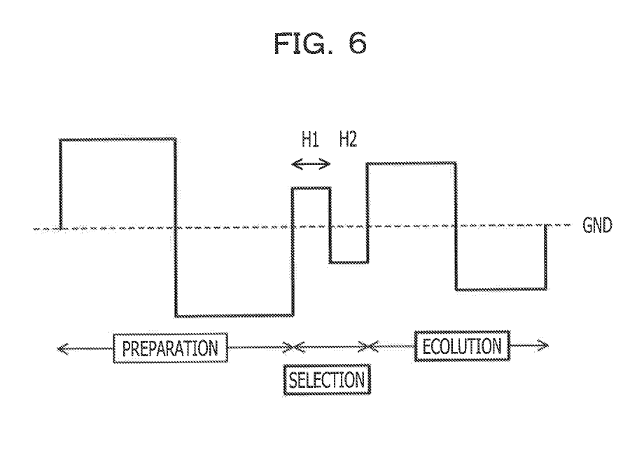

FIG. 6 illustrates a drive waveform in the DDS.

As previously mentioned, the DDS is roughly divided into three stages that are a “preparation” period, a “selection” period, and an “evolution” period from the beginning. A non-select period is provided before and after these periods. The preparation period is a period that initializes the liquid crystal to the homeotropic state by application of a large preparation pulse having a high-voltage pulse width. The selection period is a period that triggers a transition to either the planar state or the focal conic state. In the selection period, a small selection pulse with a low-voltage pulse width is applied when switching to the planar state, and no pulse is applied when switching to the focal conic state. The evolution period is a period that determines the final state of the liquid crystal to be either the planar state or the focal conic state depending on the transient state in the selection period immediately preceding the evolution period. In the evolution period, a large evolution pulse with a medium voltage pulse width is applied. The preparation pulse, the selection pulse, and the evolution pulse are each a set of positive and negative pulses.

In actuality, in the preparation period and the evolution period, rather than applying a set of positive and negative pulses with large pulse width as illustrated in FIG. 6, a plurality of positive and negative preparation and evolution pulses are applied.

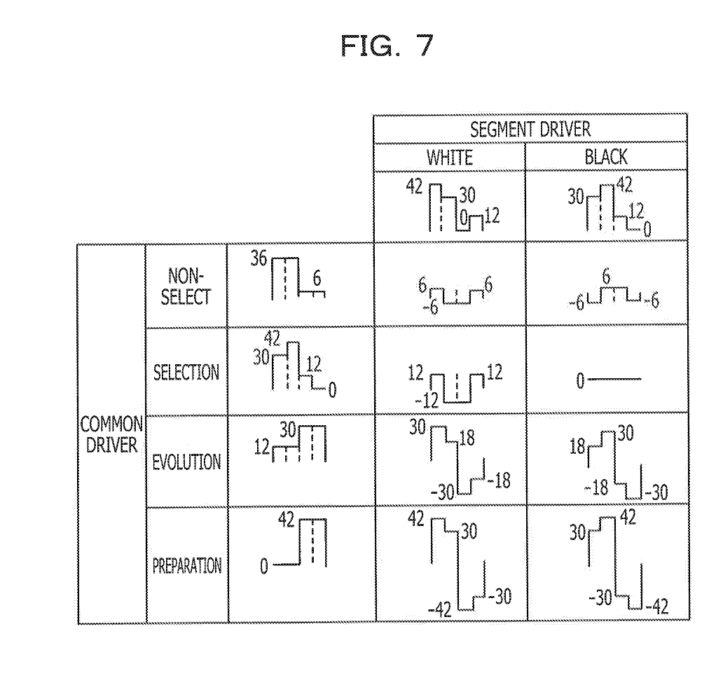

FIG. 7 illustrates drive waveforms outputted by the common driver 12 in the preparation period, the selection period, the evolution period, and the non-select period, drive waveforms outputted by the segment driver 11 to produce a white display and a black display, and waveforms applied to the liquid crystal.

In the case of executing the DDS in the first embodiment, the common driver 12 outputs six values including GND, and the segment driver 11 outputs four values including GND. Currently, general-purpose driver ICs for the passive matrix addressing have been put into practical use, which can be used as either the segment driver 11 or the common driver 12 through mode setting. Therefore, the general-purpose driver IC to be used as the segment driver 11 has a spare number of output values. In the first embodiment, a capacitance detection signal is applied to the display device 10 by making use of the spare outputs of the segment driver 11.

The common driver 12 and the segment driver 11 change output in units of periods representing four equal sub-divisions of the selection period. The segment driver 11 outputs a voltage waveform that changes to 42 V, 30 V, 0 V, and 12 V for the white display, and a voltage waveform that changes to 30 V, 42 V, 12 V, and 0 V for the black display. The common driver 12 outputs a voltage waveform that changes to 36 V, 36 V, 6 V, and 6 V in the non-select period, a voltage waveform that changes to 30 V, 42 V, 12 V, and 0 V in the selection period, a voltage waveform that changes to 12 V, 12 V, 30 V, and 30 V in the evolution period, and a voltage waveform that changes to 0 V, 0 V, 42 V, and 42 V in the preparation period.

As a result, in the preparation period, a voltage waveform that changes to 42 V, 30 V, −42 V, and −30 V is applied to the liquid crystal of the data electrodes for the white display, and a voltage waveform that changes to 30 V, 42 V, −30 V, and −42 V is applied to the liquid crystal of the data electrodes for the black display. In the evolution period, a voltage waveform that changes to 30 V, 18 V, −30 V, and −18 V is applied to the liquid crystal of the data electrodes for the white display, and a voltage waveform that changes to 18 V, 30 V, −18 V, and −30 V is applied to the liquid crystal of the data electrodes for the black display. In the selection period, a voltage waveform that changes to 12 V, −12 V, −12 V, and 12 V is applied to the liquid crystal of the data electrodes for the white display, and a voltage waveform of 0 V is applied to the liquid crystal of the data electrodes for the black display. In the non-select period, a voltage waveform that changes to 6 V, −6 V, −6 V, and 6 V is applied to the liquid crystal of the data electrodes for the white display, and a voltage waveform that changes to −6 V, 6 V, 6 V, and −6 V is applied to the liquid crystal of the data electrodes for the black display.

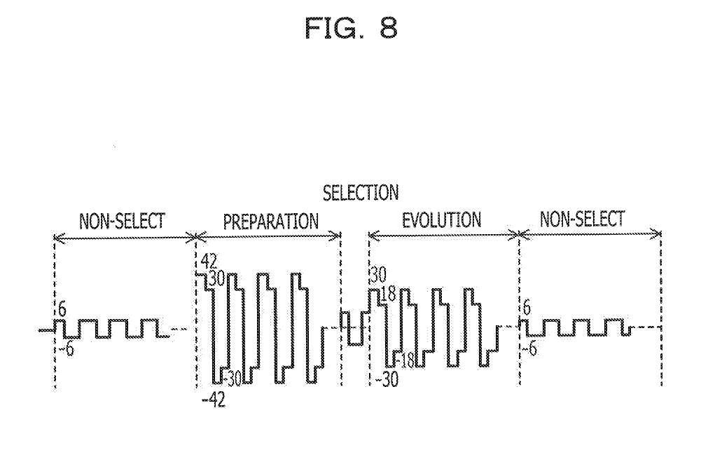

FIG. 8 more specifically illustrates a voltage waveform applied to the liquid crystal at each pixel as the common driver 12 and the segment driver 11 output the drive waveforms illustrated in FIG. 7. The voltage waveform illustrated in FIG. 8 is applied to each single scan line. The common driver 12 shifts the scan line to which to apply the signal illustrated in FIG. 8 line by line.

As illustrated in FIG. 8, the preparation period, the selection period, and the evolution period are arranged in this order, with the non-select period being arranged before and after these periods. The selection period has an application time of about 0.5 ms to 1 ms. FIG. 8 illustrates a selection pulse of ±12 V applied when switching to the planar state to produce a white display (bright display). A selection pulse of 0 V is applied during this period when switching to the focal conic state to produce a black display (dark display).

The preparation period and the evolution period each have a length several to several tens of times the length of the selection period. In the preparation period and the evolution period, a plurality of the preparation and evolution pulses illustrated in FIG. 7 are applied. The non-select period represents a pulse applied at all times to pixels that are not involved in rendering of an image. Since this pulse has a low voltage, the pulse does not change the image.

A set of the preparation, selection, and evolution pulses illustrated in FIG. 8 is applied sequentially while changing the position of the scan line. As a result, the selection pulse effects scanning/rewriting in a pipeline fashion in the application time of the selection pulse for each single line together with the preparation pulse and the evolution pulse. Therefore, an image can be rewritten at a speed of about 1 ms×768=0.77 second even in the case of the display device 10 with a high-resolution based on the XGA specifications.

To display a gray scale image, the selection period is further divided into a plurality of sub-periods so that the drive waveforms illustrated in FIG. 7 can be applied in each of the sub-periods. The ratio between the sub-periods for producing a white display and the sub-periods for producing a black display out of the plurality of sub-periods is changed. For example, a duty ratio of 100% corresponds to a case where eight sub-periods are provided, and all of the eight sub-periods produce a white display. A duty ratio of 0% corresponds to a case where all of the eight sub-periods produce a black display, and a duty ratio of 25% corresponds to a case where two sub-periods produce a white display. In the first embodiment, the selection period is about 700 μs, which is divided into sub-periods of 20 to 30 μs. Accordingly, as many as 23 to 35 sub-periods are provided. When the sub-periods for the white display are placed at the center in the selection period, the width of the selection pulse for the white display in the selection period varies with duty ratio. For the simplicity of explanation, the following description is given assuming that the width of the selection pulse in the selection period varies with duty ratio, by using the DDS drive waveform illustrated in FIG. 6.

As previously mentioned, a display apparatus using a liquid crystal with memory property is prone to lot-to-lot variability in the contrast, brightness, gamma characteristics, or the like of the display device 10. The contrast, brightness, or gamma characteristics of the display device 10 may undergo changes after prolonged use. If such variability or aging occurs, it may become difficult for the display device 10 to produce a desirable display even when driven under the same driving conditions. In particular, in the case of the DDS employed in the display apparatus according to the first embodiment, the optimal range of driving conditions is narrow, and the influence of such variability and aging of the display device 10 may become so large that a good display is not achieved under fixed driving conditions.

To adjust driving conditions, characteristics of the display device 10 related to display (brightness) are detected, and the adjustment is made on the basis of the relationship between the detected characteristics and display (brightness). As previously mentioned, it has been proposed in the past to determine driving conditions in accordance with capacitance value. The display apparatus according to the first embodiment is also configured to detect the capacitance of the display device 10, and adjust driving conditions so as to achieve desired driving conditions. However, the display apparatus according to the first embodiment is configured to detect the capacitance of the display device 10 directly without use of a dummy cell, and perform capacitance detection and driving condition adjustment by setting the display device 10 to a predetermined display state (white, black, or gray scale level).

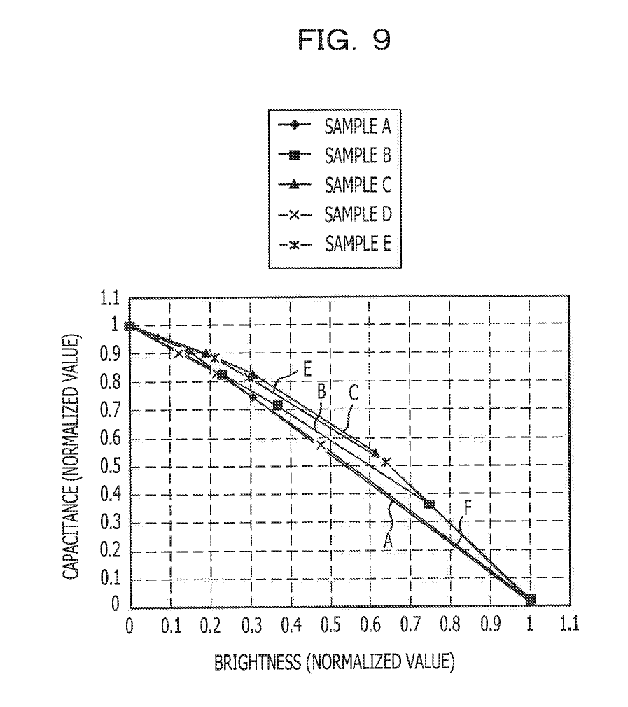

FIG. 9 illustrates measurements on the relationship between brightness (reflectance) and capacitance with respect to five samples of the display device 10. The capacitance is measured at 1 kHz, and is a normalized relative value with the brightness in the full planar state being 1 and the brightness in the full focal conic state being 0. Capacitance values lying in between 0 and 1 result in mixed states of the planar state and the focal conic state, thus displaying gray scale levels.

As is apparent from FIG. 9, the focal conic state (brightness 0) exhibits the maximum capacitance, with the capacitance decreasing monotonously toward the planar state (brightness 1). From this, it is appreciated that when a desired display is not obtained owing to lot-to-lot variability or aging, variation of brightness due to the variability or aging can be estimated on the basis of its correlation with capacitance. Accordingly, the display apparatus according to the first embodiment adjusts driving conditions by exploiting the characteristic as illustrated in FIG. 9 in which the brightness and capacitance of a cholesteric liquid crystal vary very monotonously. Specifically, the capacitance of the display device 10 is measured, and driving conditions are adjusted on the basis of the measured capacitance.

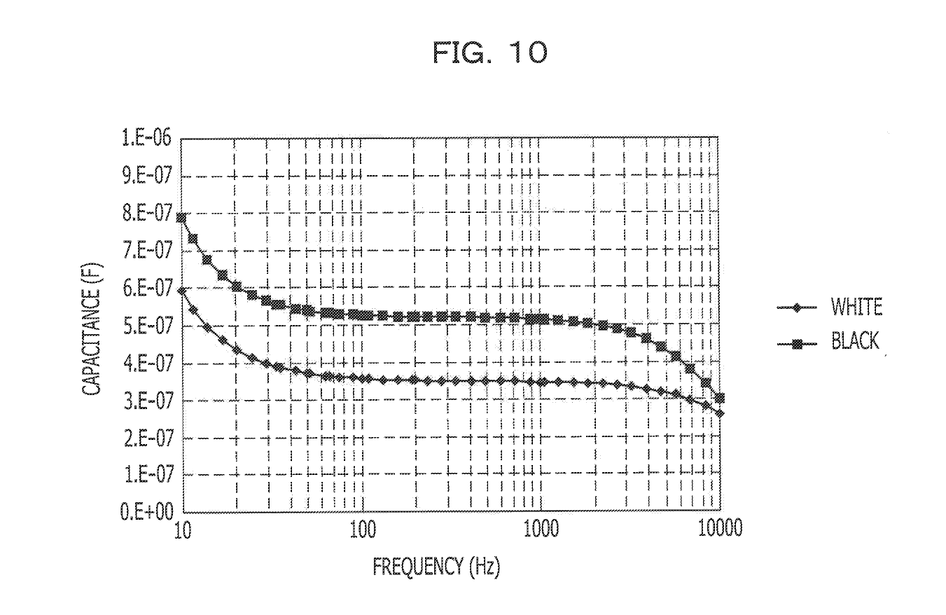

FIG. 10 illustrates the frequency characteristics of the capacitance of the display device 10. In FIG. 10, a phenomenon in which the capacitance is larger in the focal conic state than in the planar state is observed until around 10 kHz. At frequencies lower than or equal to 100 Hz, the absolute value of capacitance becomes larger. Presumably, this is because polarization begins to take place owing to polar groups and ion components contained in the liquid crystal material. Considering the ratio of capacitance between the planar state and the focal conic state, and the amount of current to be detected, it is considered preferable to use a frequency in the vicinity of 1 kHz for capacitance detection.

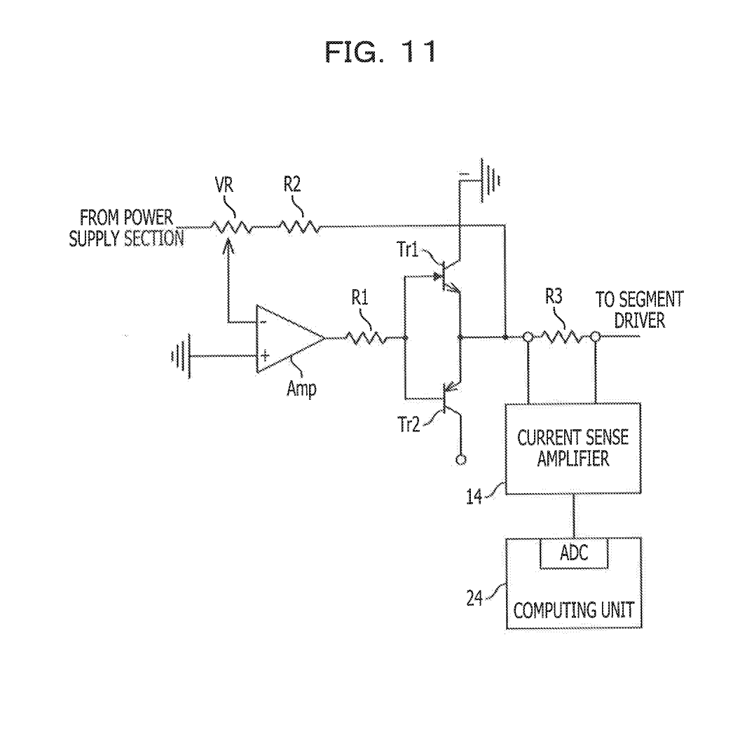

FIG. 11 illustrates the configuration of a circuit portion that outputs a capacitance detection signal in the power supply unit 13, the current sense amplifier 14, and the computing unit 24. As the current sense amplifier 14, a general-purpose current sense amplifier that allows easy input and output can be used. The power supply unit 13 generates a sawtooth or triangular wave by using a DA converter (not illustrated) or the like, and applies an original detection signal to one end of a variable resistor VR. A booster circuit having an operational amplifier Amp, a resistor R1, and transistors Tr1 and Tr2, and a resistor R2 form an amplifier circuit that amplifies the original detection signal to output a capacitance detection signal, thereby stabilizing output voltage. The amplification factor of the amplifier circuit can be adjusted by adjusting the resistance value of the variable resistor VR. For example, the resistance value of the variable resistor VR can be adjusted by adjusting the number of resistors coupled via a switch, and the adjustment is made by a control signal from the controller 23, or the like. The variable resistor VR may be a fixed resistor if adjustment of the pulse height of the capacitance detection signal is not performed. A damping resistor R3 that restricts current is placed downstream of the booster circuit. In FIG. 11, the damping resistor R3 is also used as a sensing resistor for the current sense amplifier 14. As previously mentioned, one end of the damping resistor R3 is coupled to an unused power supply terminal of the segment driver 11.

The current sense amplifier 14 used is a current sense amplifier that outputs a detected current value as an analog voltage value. The voltage of a voltage signal outputted by the current sense amplifier 14 is digitized by an AD converter (ADC) in the computing unit 24, and used for computing a capacitance value. The detection accuracy is further improved by providing a low-pass filter having an appropriate cut-off frequency between the output of the current sense amplifier 14 and the AD converter.

The power supply unit 13 generates a voltage to be supplied to each of the segment driver 11 and the common driver 12, by a voltage divider circuit. Since the DDS involves large instantaneous current consumption, it is desirable that each of the voltages formed by the voltage divider circuit in the power supply unit 13 be outputted via the booster circuit having the operational amplifier Amp and the transistors Tr1 and Tr2 illustrated in FIG. 11.

Further, in the terminal part of the power supply unit 13 which outputs a voltage to be applied to each of the segment driver 11 and the common driver 12, it is common to provide a smoothing capacitor on the order of several μF downstream of the damping capacitor. However, in the case of the terminal that outputs a capacitance detection signal illustrated in FIG. 11, it is desirable not to provide such a smoothing capacitor for the following reasons. That is, if a smoothing capacitor is provided, a composite capacitance of the capacitance of the display device 10 and the capacitance of the smoothing capacitor is detected. Consequently, the differences in detected capacitance value among white display, black display, and gray scale display states become small, causing a decrease in S/N ratio, which in turn leads to a decrease in detection accuracy.

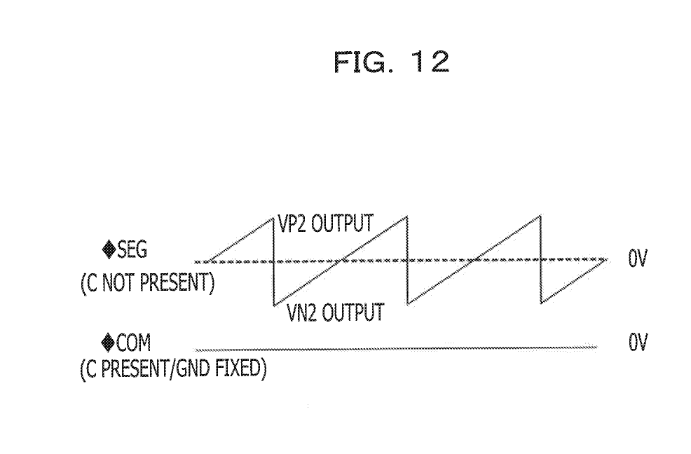

FIG. 12 illustrates the waveform of a capacitance detection signal, which is supplied to an unused power supply terminal of the segment driver 11 from the booster circuit via the damping resistor R3. The first embodiment uses a sawtooth-wave capacitance detection signal with the voltage varying between ±5 V. When applying a capacitance detection signal to the display device 10, the GND level is outputted to all the terminals of the common driver 12, and the voltage at the terminal applied with the capacitance detection signal is outputted to all the terminals of the segment driver 11. When the capacitance detection signal is varied as illustrated in FIG. 12 in this state, a voltage varying in a sawtooth-wave fashion is applied to all the pixels of the display device 10. Since a sawtooth-wave capacitance detection signal is commonly generated by a DA converter, it is desirable to provide a low-pass filter having an appropriate cut-off frequency to smooth the sawtooth-wave capacitance detection signal.

Capacitance is detected by detecting the value of the current at charge/discharge following application of a capacitance detection signal to the display device 10, by the current sense amplifier 14.

It is found that even in the case of a cholesteric liquid crystal that is inferior in capacitance characteristics to a TFT liquid crystal, the current at charge/discharge can be detected in a stable manner by use of a sawtooth-wave capacitance detection signal.

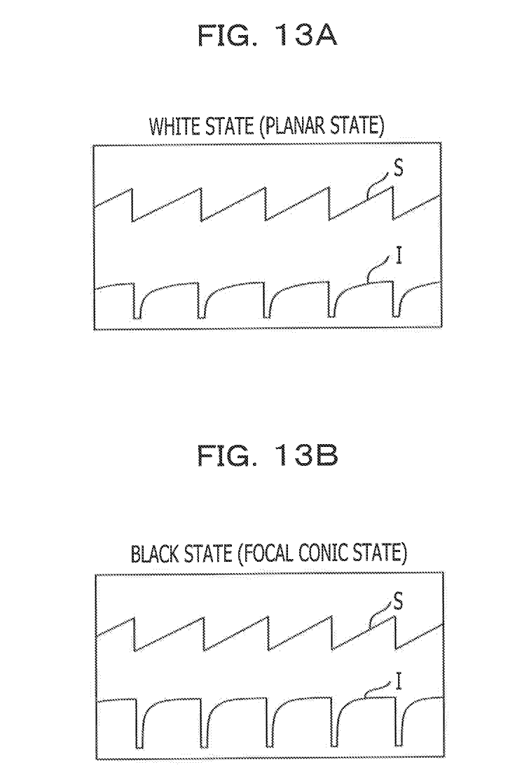

FIGS. 13A and 13B illustrate the results of an experiment in which a test cell of a cholesteric liquid crystal is used to detect capacitance in accordance with the circuit configuration illustrated in FIG. 11. FIG. 13A illustrates a sawtooth-wave capacitance detection signal S when all pixels are displayed in white (the planar state), and the corresponding current I at charge/discharge. FIG. 13B illustrates a sawtooth-wave capacitance detection signal S when all pixels are displayed in black (the focal conic state), and the corresponding current I at charge/discharge. In FIGS. 13A and 13B, the current I rapidly increases with increase of the signal S, and then becomes substantially invariant. It is confirmed that at the time when the current I becomes substantially invariant, the ratio of the current value in the focal conic state to the current value in the planar state is approximately 1.4, which substantially coincides with the ratio of capacitance between white display and black display illustrated in FIG. 10.

A prototype of a CR oscillation circuit with the test cell replaced as a capacitor is fabricated, and its oscillating frequency is measured. The results indicate that the oscillating frequency in the planar state is approximately 1.4 times the oscillating frequency in the focal conic state. However, situations where the oscillating frequency becomes unstable with large fluctuations are frequently observed. Accordingly, in the case of a cholesteric liquid crystal, more stable capacitance detection can be achieved by detecting capacitance on the basis of the current at charge/discharge produced upon application of a sawtooth-wave capacitance detection signal, than by detecting capacitance by detecting oscillating frequency.

In the detection of capacitance mentioned above, the capacitance of the display device 10 at the time of white/black display is detected. In this regard, by setting the display device 10 to a gray scale display state, it is also possible to detect capacitance in the gray scale display state. While a sawtooth-wave capacitance detection signal is used in the detection of capacitance mentioned above, the same measurement is possible by using a triangular-wave capacitance detection signal.

Next, a method of adjusting driving conditions in the display apparatus according to the first embodiment is described.

In the case of adjusting driving conditions in the DDS, the conditions that can be adjusted include the voltages of the preparation pulse and evolution pulse, the voltage of the selection pulse for the white display, the pulse width (duty ratio) of the selection pulse, and so on. In the first embodiment, the voltage of the evolution pulse (evolution voltage) and the duty ratio of the selection pulse are adjusted. The evolution voltage is adjusted because the evolution voltage is a dominant factor that strongly affects the contrast of display. The duty ratio of the selection pulse is adjusted because of all factors that give rise to gradation, this duty ratio can be adjusted relatively easily, and precise adjustment is possible.

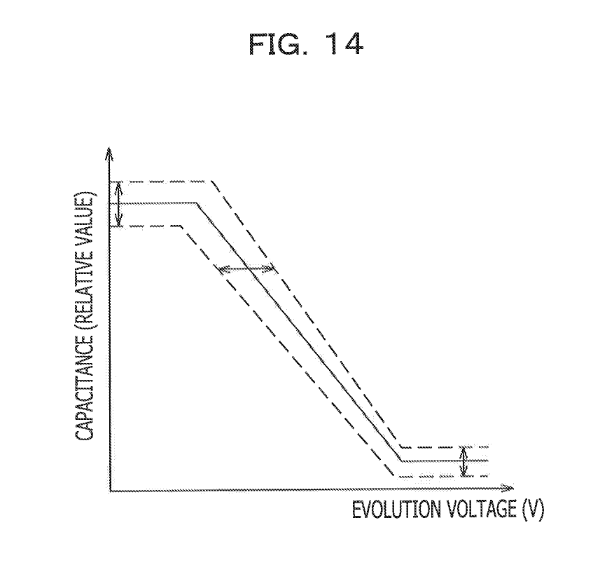

FIG. 14 illustrates capacitance variation of the display device 10 with varying evolution voltage in a case where the display device 10 is driven by the DDS under the driving conditions illustrated in FIGS. 6 to 8, and by setting the duty ratio of the selection pulse to a predetermined value (for example, 50%).

In FIG. 14, the solid line indicates an example of variation in a single sample of the display device 10. When the display device 10 is driven at evolution voltages lower than a certain value, the capacitance of the display device 10 after driving becomes a high, invariant value. As the evolution voltage is increased, the capacitance of the display device 10 after driving decreases. When the evolution voltage reaches a certain value, the capacitance of the display device 10 after driving becomes a low, invariant value. Such capacitance variation fluctuates owing to variability or aging. For example, the values at which capacitance becomes invariant on the high side and low side fluctuate upward or downward, the variation in the intermediate section between the two sides fluctuates (in the horizontal direction in FIG. 14) with respect to the evolution voltage, and so does the inclination of the variation in the intermediate section.

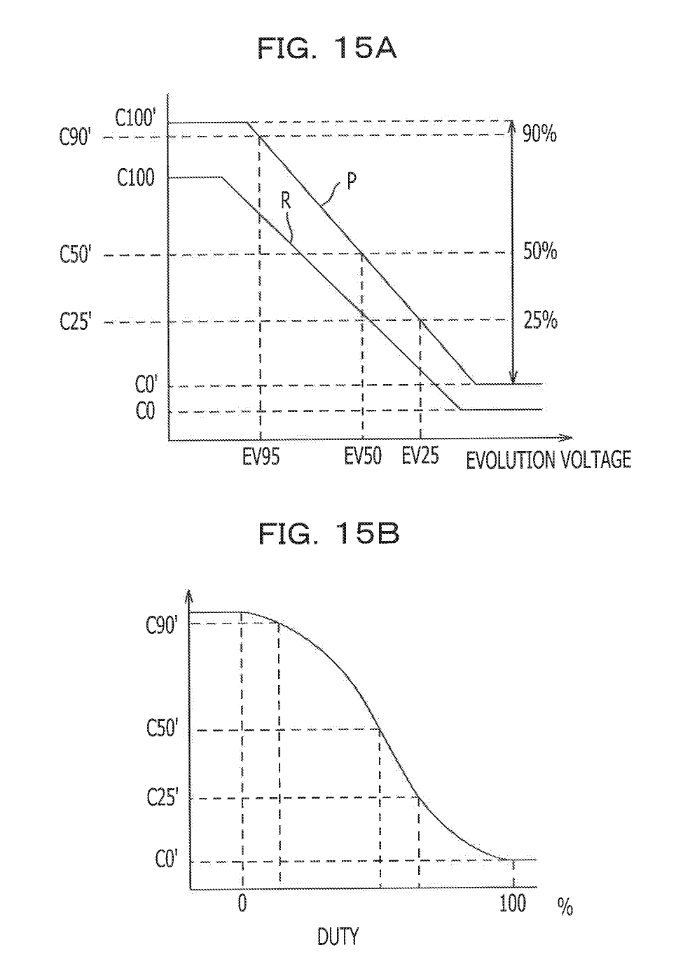

FIGS. 15A and 15B illustrate a method of adjusting driving conditions in the display apparatus according to the first embodiment. FIG. 15A illustrates first-stage and second-stage adjustments, and FIG. 15B illustrates a third-stage adjustment.

In FIG. 15A, symbol R indicates a representative example of the capacitance variation of the display device 10 with varying evolution voltage as described above with reference to FIG. 14. This example R is pre-stored as a reference example, and the driving conditions used in that case are also stored as reference driving conditions. For example, a value C100 at which the capacitance becomes invariant on the high side, a value C0 at which the capacitance becomes invariant on the low side, and the like are stored. In addition, the evolution voltages when the value of capacitance lies between C100 and C0, for example, 25%, 50%, or 90%, and the like are also stored.

Symbol P indicates the capacitance variation with respect to the evolution voltage of the display device 10 for which driving conditions are to be adjusted. The capacitance variation P is such that, in comparison to the reference example R, the values of C100 and C0 increases to C100 and C0′, respectively, and the inclination in the intermediate section increases. In addition, the values of capacitance lying in between C100 and C0, such as 25%, 50%, and 90%, and the corresponding values of evolution voltage at that time also increase.

In a driving condition adjusting method according to the first embodiment, C100′ and C0′ are detected in the first stage.

In the second stage, the evolution voltage is determined so that a predetermined capacitance value falling between C100′ and C0′ (for example, 25%, 50%, or 90%) can be obtained by varying the duty ratio of the selection pulse. In other words, the evolution voltage is determined so as to achieve a close-to-maximum level of contrast and brightness.

While the evolution voltage is varied in the first embodiment as mentioned above, it is not possible to vary C100′ and C0′ solely by varying the evolution voltage. As illustrated in FIG. 15B, if the evolution voltage is set too large, cases may arise in which the capacitance becomes C0′ even when the duty ratio of the selection pulse is 50% or less, making gray scale display difficult. If the evolution voltage is further increased, cases may arise in which the capacitance becomes C0′ even when the duty ratio of the selection pulse is close to 0%, which makes display itself difficult.

Accordingly, in the first embodiment, by bringing C100′ and C0′ into correspondence with luminance 0 and 100 of display (in relative value), the evolution voltage is set so that the intermediate gray scale portion varies with variation of the duty ratio of the selection pulse.

In the third stage, variation of the duty ratio of the selection pulse is determined so that the variation in the intermediate gray scale portion becomes linear.

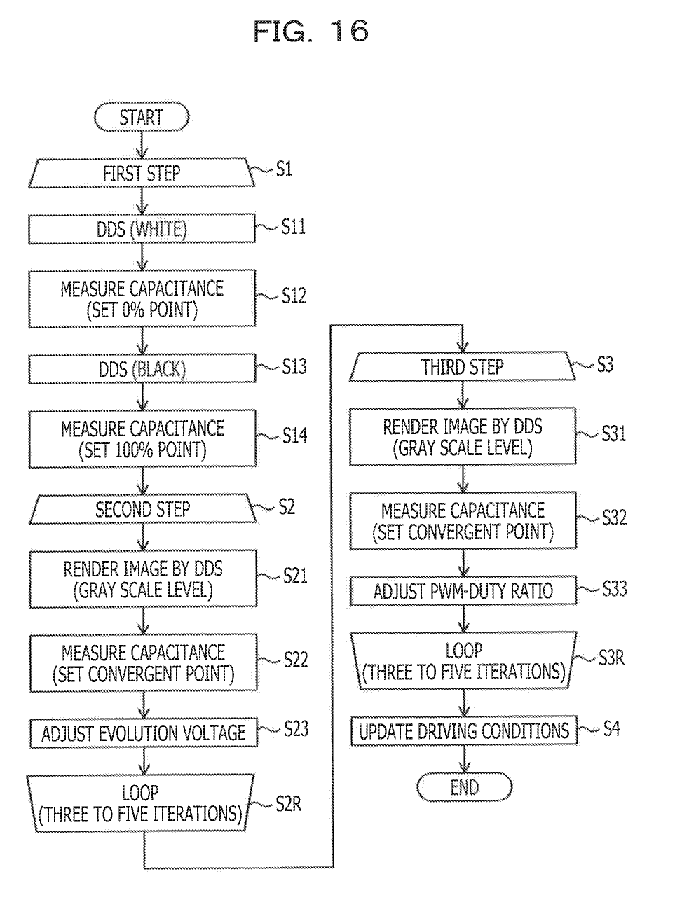

FIG. 16 is a flowchart illustrating an automatic adjustment process for driving conditions in the display apparatus according to the first embodiment. The process includes a first step S1, a second step S2, a third step S3, and a final step S4. In the first step S1, C0′ and C100° mentioned above are detected, and brought into correspondence with luminance 0 and 100 (in relative value), respectively. In the second step S2, the evolution voltage is set so that a predetermined capacitance value in the intermediate gray scale portion determined from C0 and C100′ is obtained. In the third step S3, with the determined evolution voltage, the relationship between the capacitance in the intermediate gray scale portion and the duty ratio of the selection pulse is set. In the final step S4, driving conditions are updated in accordance with the evolution voltage and the duty ratio of the selection pulse that have been determined.

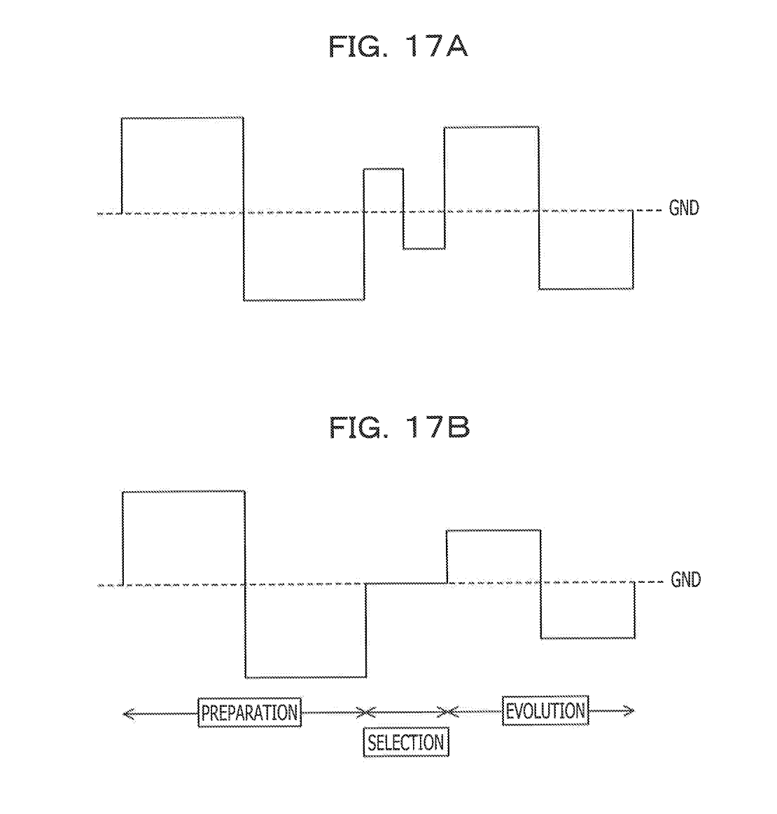

In step S11 in the first step S1, an image is rendered by setting all the pixels of the display device 10 to the white display state (planar state) by the DDS. In step S11, to ensure that all the pixels be set to the white display state, as illustrated in FIG. 17A, the duty ratio of the selection pulse is set to 100% and, further, the evolution voltage is set higher than normal.

In step S12, the capacitance of the display device 10 in the white display state set in step S11 is measured, and the measured value is set as a 0% point. Therefore, C0′ becomes the 0% point.

In step S13, an image is rendered by setting all the pixels of the display device 10 to the black display state (focal conic state) by the DDS. In step S13, to ensure that all the pixels be set to the black display state, as illustrated in FIG. 17B, the duty ratio of the selection pulse is set to 0% (no selection pulse) and, further, the evolution voltage is set lower than normal.

In step S14, the capacitance of the display device 10 in the black display state set in step S13 is measured, and the measured value is set as a 100% point. Therefore, C100′ becomes the 100% point.

The second step S2 includes steps S21 to S23. As indicated by step 2R, these steps S21 and S23 are iterated three to five times.

In step S21, an image is rendered by setting all the pixels of the display device 10 to a gray scale display state (a combination of the planar state and the focal conic state). The gray scale level to be set may be any arbitrary level of gray, such as 90%, 50%, or 25%. When setting to 25%, under pre-stored driving conditions, by setting the duty ratio of the selection pulse to 25%, all the pixels of the display device 10 are driven to a gray scale display state by the DDS. If the gray scale level to be set is 90%, this is preferable from the viewpoint of display contrast because the evolution voltage is set so as to obtain a close-to-maximum level of display contrast.

In step S22, the capacitance of the display device 10 in the gray scale display state set in step S21 is measured.

In step S23, from the capacitances C0′ and C100′ corresponding to the 0% point and the 100% point set in steps S12 and S14, respectively, a target capacitance value corresponding to the gray scale level to be set is computed, and the capacitance value measured in step S22 is compared with the target capacitance value. Then, on the basis of the comparison result, the evolution voltage is adjusted so that the measured capacitance value becomes the target capacitance value.

Steps S21 to S23 are iterated, and when the measured capacitance value obtained in step S22 becomes close to the target capacitance value, the step S2 is terminated, and the processing proceeds to step S3.

The method of adjusting the evolution voltage may be any method that adjusts the evolution voltage so that a measured capacitance value becomes a target capacitance value. A root-finding algorithm exists as such a method. Representative examples of existing root-finding algorithm include the Newton's method and the bisection method. Examples using these methods are described below.

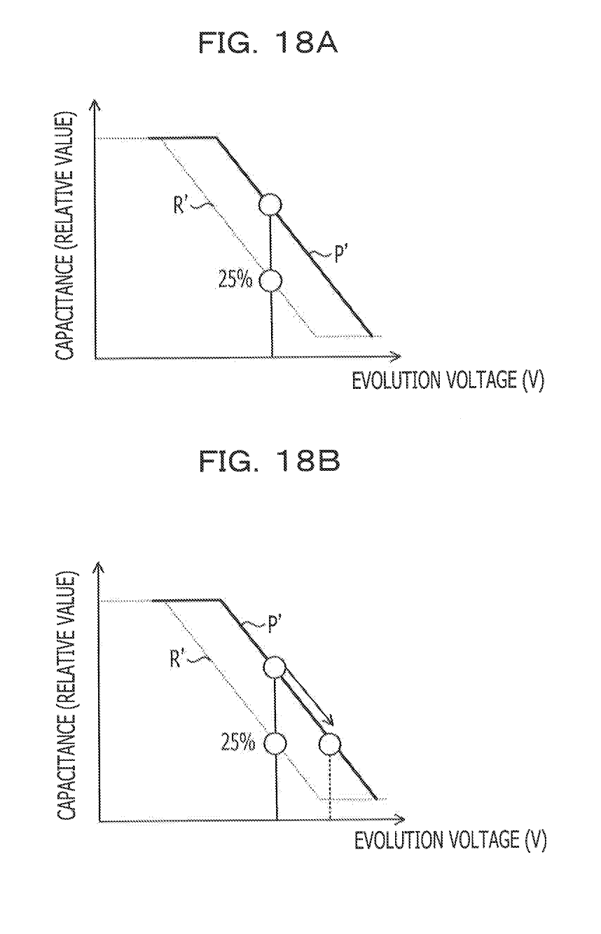

FIGS. 18A and 18B illustrate a method of adjusting the evolution voltage by the Newton's method so that a measured capacitance value becomes a target capacitance value, in a case where the gray scale level to be set is 25%.

In the Newton's method, a standard capacitance variation characteristic with respect to the evolution voltage as illustrated in FIG. 14 and FIG. 15A is stored in advance. As such a characteristic, simply the gradient and intercept of a linear function may be stored. In FIGS. 18A and 18B, symbol R′ represents a standard capacitance variation characteristic, and symbol P′ represents the capacitance variation characteristic to be adjusted.

As illustrated in FIG. 18A, for the standard capacitance variation characteristic, a standard 25% evolution voltage with which the capacitance value is at the 25% point from C0′ (the range between C0′ and C100′ being 100%) is found from a stored characteristic. With the standard 25% evolution voltage, by setting the duty ratio to 25%, all the pixels of the display device 10 are driven to a gray scale display state by the DDS. Suppose that the capacitance measured in this state is the value at the 50% point from C0′.

As illustrated in FIG. 18B, the amount of change of the evolution voltage that brings the capacitance from 50% to 25% is determined from the stored gradient, and the standard 25% evolution voltage is changed by the determined amount of change. Then, performing the same process again with the changed evolution voltage brings the measured capacitance closer to the 25% value from C0′. By iterating such a process several times, it is possible to determine the evolution voltage that causes the capacitance to become close to the 25% value from C0′. While the capacitance at the 25% point from C0′ is taken as an example in the present case, as previously mentioned, the value may be 50% or 90%.

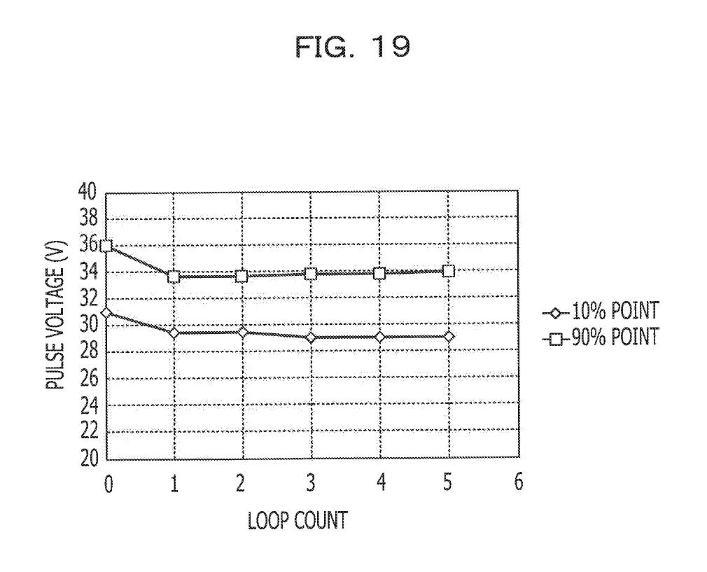

FIG. 19 illustrates variation of the evolution voltage in a case where the Newton's method is applied for capacitances at the 10% and 90% points from C0′. It can be appreciated that more than two or three iterations converge to a substantially invariant value.

It is recognized that the Newton's method tends to diverge rather than converge if the object for which a solution is to be found has the property of changing too abruptly or changing irregularly. However, since the evolution voltage-capacitance characteristic used when adjusting the evolution voltage varies very monotonously with respect to the evolution voltage, the Newton's method can be applied to achieve a convergence with near certainty.

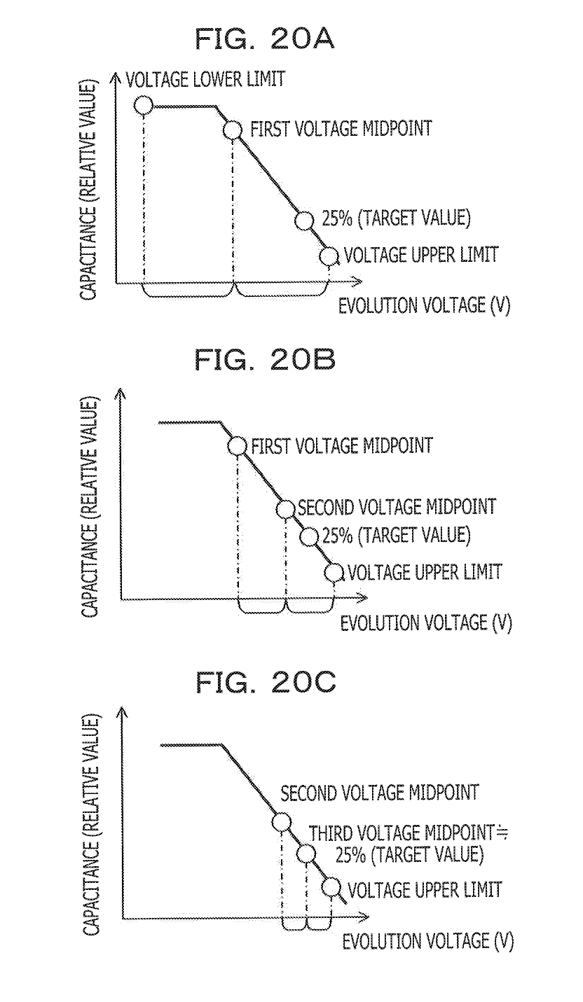

FIGS. 20A to 20C illustrate a method of adjusting the evolution voltage by the bisection method so that a measured capacitance value becomes a target capacitance value, in a case where the gray scale level to be set is 25%.

In the bisection method, a standard capacitance variation characteristic with respect to the evolution voltage may not be stored in advance.

As illustrated in FIG. 20A, a first voltage midpoint is set between the voltage upper limit and the voltage lower limit within the variable range of the evolution voltage. Then, by setting the evolution voltage to the first voltage midpoint, and the duty ratio to 25%, all the pixels of the display device 10 are driven to a gray scale display state by the DDS. Suppose that the capacitance value measured in this state is larger than the capacitance value at the 25% point from C0′. Therefore, it is determined that the first voltage midpoint is small, and is to be increased.

As illustrated in FIG. 20B, a second voltage midpoint is set between the first voltage midpoint and the voltage upper limit. Then, by setting the evolution voltage to the second voltage midpoint, and the duty ratio to 25%, all the pixels of the display device 10 are driven to a gray scale display state by the DDS. Suppose that the capacitance measured in this state is still larger than the capacitance value at the 25% point from C0′. Therefore, it is determined that the second midpoint is small, and is to be increased.

As illustrated in FIG. 20C, a third voltage midpoint is set between the second voltage midpoint and the voltage upper limit. Then, by setting the evolution voltage to the third voltage midpoint, and the duty ratio to 25%, all the pixels of the display device 10 are driven to a gray scale display state by the DDS. If the capacitance measured in this state equals the capacitance value at the 25% point from C0′, the third voltage midpoint is determined to be an appropriate evolution voltage.

Generally speaking, as compared with the Newton's method, the bisection method is less likely to diverge but converges more slowly. However, as mentioned above, since the evolution voltage-capacitance characteristic varies very monotonously with respect to the evolution voltage, after five steps of iterations, the result converges to a generally invariant value.

Returning to FIG. 16, in the third step S3, the evolution voltage determined in step S2 is used to set the relationship between capacitance in the intermediate gray scale portion and the duty ratio of the selection pulse.

In step S31, all the pixels of the display device 10 are driven to a target gray scale display state that displays one of the gray scale levels to be displayed. This process is substantially the same as step S21.

In step S32, the capacitance of the display device 10 in the target gray scale display state set in step S31 is measured.

In step S33, a target capacitance value corresponding to the target gray scale display state is computed, and the capacitance value measured in step S32 is compared with the target capacitance value. Then, on the basis of the comparison result, the duty ratio of the selection pulse is determined so that the measured capacitance value becomes the target capacitance value.

Steps S31 to S33 are iterated, and step S3 is terminated when the measured capacitance value obtained in step S32 becomes close to the target capacitance value.

In the case of the DOS, the very rapid response of the liquid crystal makes it intrinsically difficult to produce gray scale levels. Therefore, the number of gray scale levels that can be displayed is about three to seven levels. The third step is iterated for each of these gray scale levels, and once the duty ratio of the selection pulse is determined for every gray scale level to be displayed, the processing proceeds to step S4.

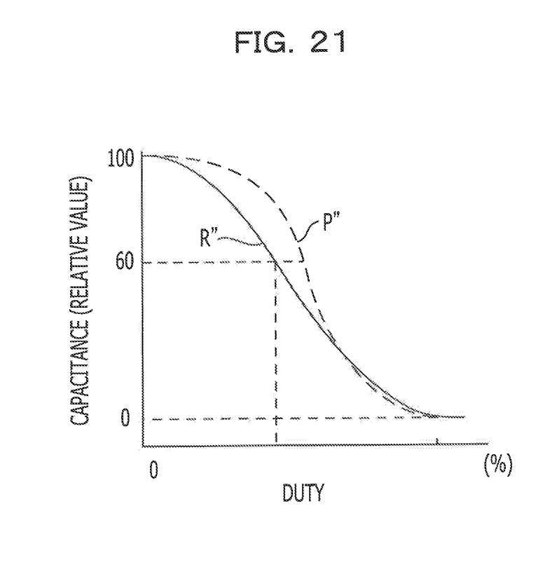

FIG. 21 illustrates the adjustment in the third step S3, depicting variation of capacitance with respect to the duty ratio of the selection pulse. In FIG. 21, symbol R″ represents a standard duty ratio versus capacitance variation characteristic, and symbol P″ represents the duty ratio versus capacitance variation characteristic to be adjusted. This example corresponds to a case where the evolution voltage is determined by setting to a 25% gray scale level in the second step S2. In this case, setting the duty ratio of the selection pulse to 25% and driving by the DOS with the evolution voltage determined in step S2 yields a desired value of capacitance, i.e., gray scale. However, in FIG. 21, the characteristic of the display device 10 to be adjusted has a steep gradient in comparison to the assumed characteristic R. Consequently, driving at the assumed selection pulse duty ratio does not result in the assumed capacitance (gray scale level). For example, for the assumed characteristic R″, the capacitance value (gray scale level) at the 60% point is obtained by setting the duty ratio to 40%. However, for the characteristic P″ of the display device 10 to be adjusted, the duty ratio is to be set to 50%.

For a given capacitance in the intermediate gray scale portion, the duty ratio of the selection pulse that provides such a capacitance (gray scale level) is determined, and the driving conditions are updated to the duty ratio of the selection pulse determined in this way. For each of capacitances in the intermediate gray scale portion, the Newton's method or the bisection method is applied to determine the corresponding duty ratio of the selection pulse. In the case of the DDS, the very rapid response of the liquid crystal makes it intrinsically difficult to produce gray scale levels. Therefore, in determining the duty ratio of the selection pulse, although the Newton's method can be used as well, the bisection method that has a lower risk of divergence can determine an optimal value in a more favorable manner.

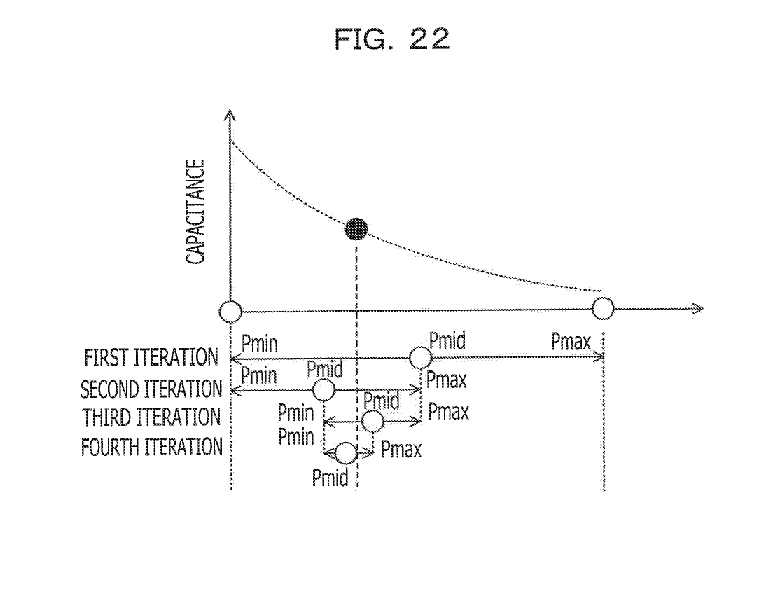

FIG. 22 illustrates the processing in a case where the third step S3 is performed by using the bisection method. In the bisection method, the upper limit Pmax and lower limit Pmin of the search range of Duty ratio of PWM are set. In the first iteration of the search process, a gray scale display is produced by setting the Duty ratio of PWM to the midpoint value Pmid=(Pmax+Pmin)/2 of Pmax and Pmin, and the capacitance value at that time is measured. If it is determined that the difference between the measured capacitance value and a target capacitance value is larger than a threshold, the second iteration of the search process is performed. As illustrated in FIG. 22, if the measured capacitance value is smaller than the target capacitance value, by setting Pmid as Pmax, a gray scale display is produced by setting the Duty ratio of PWM to the midpoint value Pmid=(Pmax+3Pmin)/4 of Pmin and Pmax, and the capacitance value at that time is measured. If it is determined that the difference between the measured capacitance value and the target capacitance value is larger than the threshold, the third iteration of the search process is performed. As illustrated in FIG. 22, if the measured capacitance value is larger than the target capacitance value, by setting Pmid as new Pmin, a gray scale display is produced by setting the Duty ratio of PWM to the midpoint value Pmid=(3Pmax+5Pmin)/8 of Pmin and Pmax, and the capacitance value at that time is measured. If it is determined that the difference between the measured capacitance value and the target capacitance value is larger than the threshold, the fourth iteration of the search process is performed. As illustrated in FIG. 22, if the measured capacitance value is smaller than the target capacitance value, by setting Pmid as next Pmax, a gray scale display is produced by setting the Duty ratio of PWM to the midpoint value Pmid=(5Pmax+11Pmin)/8 of Pmin and Pmax, and the capacitance value at that time is measured. If the difference between the measured capacitance value and the target capacitance value becomes lower than or equal to the threshold, the search process is stopped, and the Duty ratio of PWM is set as Pmid=(5Pmax+11Pmin)/8.

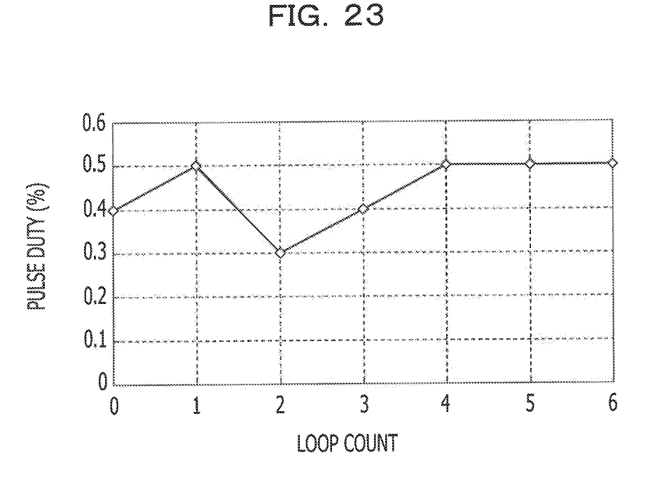

FIG. 23 illustrates variation of duty ratio in a case where the bisection method is applied to determine the duty ratio that provides a capacitance at the 60% point. It can be appreciated that after performing five or more iterations, the result converges to a substantially invariant value.

As described above, the display apparatus according to the first embodiment can automatically optimize driving conditions to produce a good display at all times, even in cases where the characteristics of the display device 10 fluctuate owing to lot-to-lot variability or aging.

While display is optimized by performing the above-mentioned automatic driving-condition adjustment in this way, this process results in a long processing time and, in some cases, and the adjustment takes several minutes to end. In particular, as compared with the Newton's method, the bisection method can determine an optimal value in a more favorable manner but takes longer to converge. Accordingly, it is desired to shorten the time taken to finish the automatic driving-condition adjustment process.

In the case of the search algorithm for optimal driving conditions illustrated in FIGS. 16 to 23, the search range and the number of loops are fixed. For this reason, regardless of the magnitude of deviation of driving conditions, a certain amount of adjustment time is taken after a start command for automatic adjustment is given.

Accordingly, in the first embodiment, by adding flexibility to the search algorithm for optimal driving conditions, the following search algorithm that further shortens adjustment time while retaining high adjustment accuracy is used. In this search algorithm, the first automatic driving-condition adjustment process is performed in the manner as mentioned above, but in the second and subsequent iterations of the automatic driving-condition adjustment process, the degree of deviation of driving conditions is detected, and the algorithm is simplified in accordance with the degree of deviation, thereby shortening processing time.

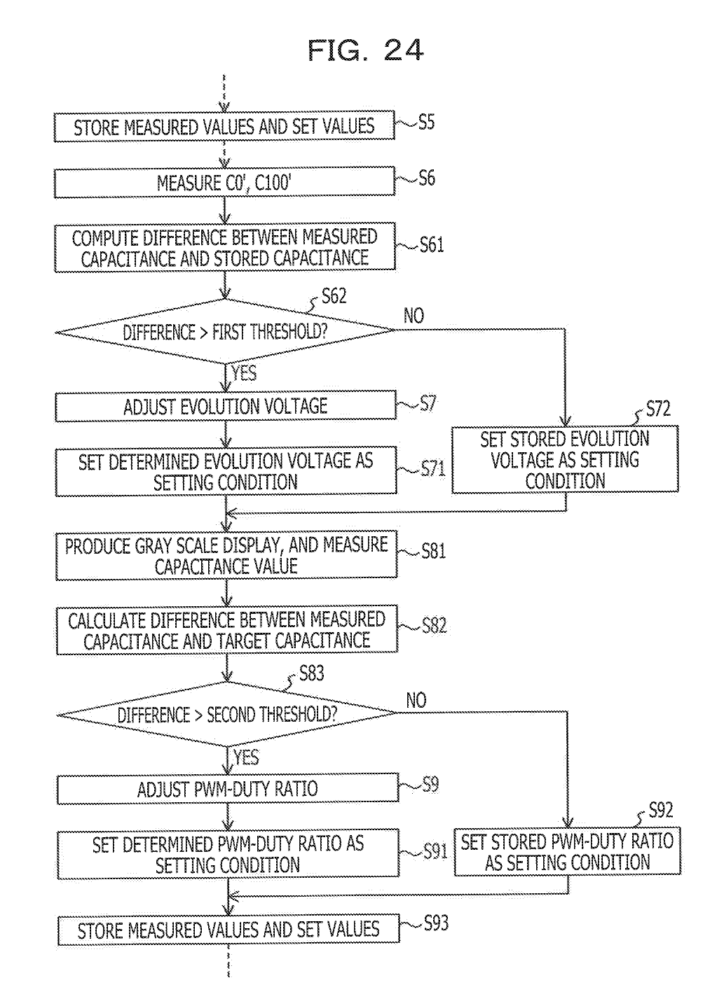

FIG. 24 is a flowchart illustrating an automatic adjustment process for driving conditions using this search algorithm.

As mentioned above, the automatic driving-condition adjustment process illustrated in FIG. 16 is previously performed at least one. Accordingly, capacitances corresponding to the white display and the black display have been measured, and the evolution voltage and the duty ratio of the selection pulse that provides a target capacitance value have been determined.

In step S5, the controller 23 stores the capacitances (C0′ and C100′) measured in the previous automatic driving-condition adjustment process, and the evolution voltage and the duty ratio of the selection pulse that have been set, into a memory (not illustrated).

After step S5, for the purpose of maintenance or the like, an automatic driving-condition adjustment process is started again.

First, step S6 is performed. In step S6, substantially the same processing as the first step S1 including steps S11 to S14 illustrated in FIG. 16 is performed. As a result, capacitance values C0′ and C100′ respectively corresponding to the 0% point and the 100% point are measured.

In step S61, differences D0 and D100 between the capacitance values C0′ and C100′ measured in step S6, and the previous capacitance values stored in step S0 are computed, respectively. Symbol D0 denotes the absolute value of the difference between the capacitance value C0′ measured in step S6 and the capacitance value C0′ stored in step S5. Symbol D100 denotes the absolute value of the difference between the capacitance value C100′ measured in step S6 and the capacitance value C100′ stored in step S5.

In step S62, it is determined whether or not each of the differences is larger than a first threshold. The processing proceeds to step S7 if the difference is larger than the first threshold, and proceeds to step S72 if the difference is smaller than the first threshold. As mentioned above, there are two differences, D0 and D100, and accordingly, two values are set for the first threshold. While the present case assumes that the processing proceeds to step S7 if at least one of the differences D0 and D100 is larger than the first threshold, the processing may proceed to step S7 only if both the differences are larger than the first threshold. When the processing proceeds to step S72, adjustment of the evolution voltage is skipped.

As described later, the processing performed in step S7 is an adjustment of the voltage in the evolution period which determines the contrast of display. The evolution voltage allows for a relatively large margin of error, and although depending on the material or structure of the panel, there is a voltage range of 2V to 3V for obtaining a certain contrast. Therefore, the first threshold can be set relatively large, that is, the condition for skipping the adjustment can be set relatively loose. For example, the first threshold for each of the differences D0 and D100 may be set to 5% from each of C0 and C100′. Accordingly, if C0′ or C100′ measured in step S6 has changed by not more than 5% from C0′ or C100′ stored in S6, the processing proceeds to step S72, and the evolution voltage adjustment process is skipped. Conversely, if C0′ or C100′ measured in step S6 has changed by more than 5% from C0′ or C100′ stored in 56, the processing proceeds to step S7.

In step S7, substantially the same processing as the second step S2 including steps S21 to S2R illustrated in FIG. 16 is performed. As a result, the evolution voltage is determined.

In step S71, the evolution voltage determined in step S7 is set as a setting condition.

In step S72, the evolution voltage stored in step S5 is set as a setting condition.

In step S81, with the set evolution voltage, the processing in steps S31 and S32 illustrated in FIG. 16 is executed to produce a predetermined gray scale display, and the capacitance in this case is measured. The predetermined gray scale display is produced at the Duty ratio of PWM used in the previous processing stored in step S5, by using the evolution voltage that has been set.

In step S82, the difference between the capacitance value measured in step S81, and the gray scale capacitance value stored in step S5 is computed.

In step S83, it is determined whether or not the difference computed in step S82 is larger than a second threshold. The processing proceeds to step S9 if the difference is larger than the second threshold, and proceeds to step S92 if the difference is not larger than the second threshold.

In step S9, the Duty ratio of PWM is adjusted. This adjustment process is similar to step S3 including steps S31 to S3R illustrated in FIG. 16. However, this adjustment process differs in that the process is terminated when the difference between a measured capacitance value and a target capacitance value becomes less than or equal to the second threshold, and in the method of computing a midpoint value. This process is described later.

In step S91, the Duty ratio of PWM determined in step S9 is set as a setting condition.

In step S92, the Duty ratio of PWM stored in step S5 is set as a setting condition.

In step S93, capacitance values and driving conditions are stored. Specifically, the capacitance values C0 and C100′ measured in step S6, the evolution voltage set in step S71 or S72, and the Duty ratio of PWM set in step S91 or S92 are stored. For example, if the evolution voltage is set in step S71, the evolution voltage determined in step S7 is stored, and if the evolution voltage is set in step S72, the evolution voltage determined in the previous adjustment process stored in step S5 is stored. Also, if the Duty ratio of PWM is set in step S91, the Duty ratio of PWM determined in step S9 is stored, and if the Duty ratio of PWM is set in step S92, the Duty ratio of PWM determined in the previous adjustment process stored in step S5 is stored.

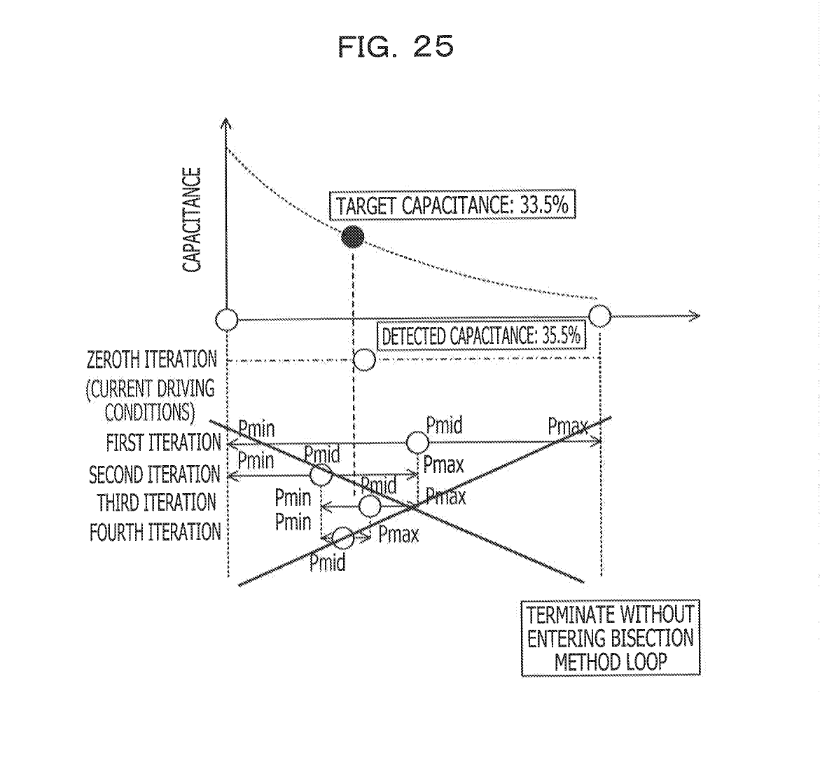

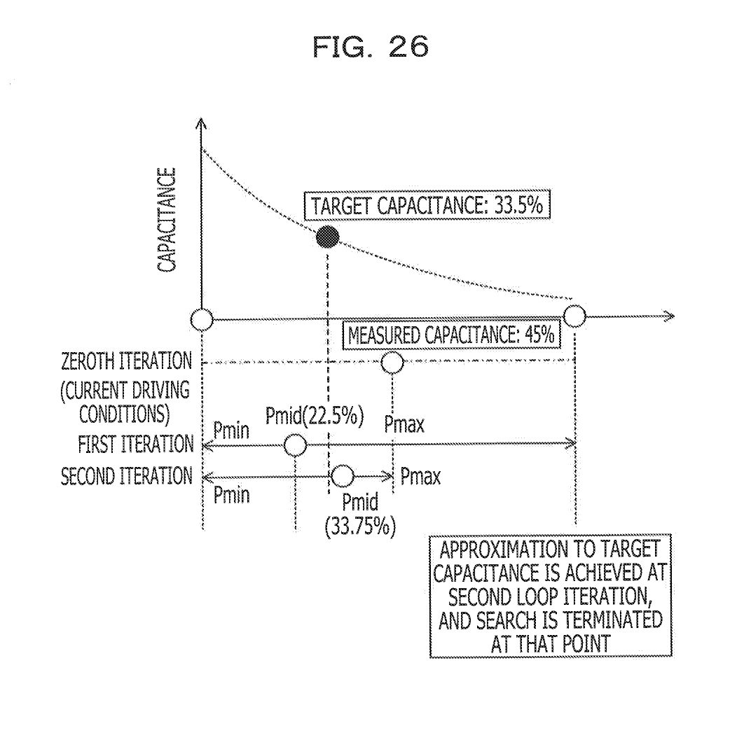

Next, a case where the processing in steps S83 to S92 is performed by using the bisection method is described in detail with reference to FIGS. 25 and 26. In this case, it is assumed that the three RGB layers of the display device 10 each display 16 levels of gray.

FIG. 25 illustrates processing in the case where the difference computed in step S82 is determined to be not more than the second threshold in step S83. As previously mentioned, in step S81, by using the evolution voltage that has been set, a gray scale display is produced at the Duty ratio of PWM used in the previous processing stored in step S5, and the capacitance value at that time is measured. In FIG. 25, the capacitance value measured when a gray scale display is produced by setting Pmax as 100%, Pmin as 0%, and the stored Duty ratio of PWM as 35% is 35.5%. Since the target capacitance is 33.5%, the difference is 2%, which is not more than the second threshold. Accordingly, the processing proceeds from step S83 to step S92, and step S9 is not performed. In other words, a Duty ratio of PWM search based on the bisection method is not performed.

The second threshold, that is, the criterion for determining whether or not to skip the Duty ratio of PWM search based on the bisection method is determined on the basis of whether or not it is possible to form 16 predetermined levels of gray as a precondition. For example, when dividing into 16 levels of gray with respect to the range of capacitances 0% to 100%, the width of capacitance for each level of gray is 1001(16−1)=6.7%, and thus it is ideal to divide into 16 levels of gray in steps of 6.7%. Accordingly, the second threshold is desirably not more than 3.3%. This means that in the case of displaying N levels of gray, it is desirable that the difference between the measured capacitance and the target capacitance be not more than ±100/2(N−1).

FIG. 26 illustrates an example of the processing in step S9. Suppose that a gray scale display is produced by using the evolution voltage set in step S81 and at the Duty ratio of PWM used in the previous processing stored in step S5, and the capacitance value measured at this time is 45%. Since the target capacitance value is 33.5% also in this case, the difference is 11.5%. Thus, in step S83, it is determined that the difference is not less than the second threshold, and step S9 is performed.

In step S9, unlike the third step S3 illustrated in FIG. 16, by setting the midpoint value between a capacitance value measured by producing a gray scale display and Pmax or Pmin, the search range is narrowed from the beginning, thereby shortening search time. As illustrated in FIG. 26, the measured capacitance value 45% measured in step S81 is larger than the target capacitance value 33.5%. Thus, the first search iteration is performed by setting Pmax to the measured capacitance value 45%, and setting the Duty ratio of PWM to the midpoint value Pmid (22.5%) between Pmin (0%) and Pmax (45%). Since the bisection method is started by setting Pmax and Pmin of the search range as 45% and 0%, respectively, as illustrated in FIG. 26, with only two loop iterations, the error in capacitance value satisfies a specified value, and it is possible to terminate the search.

The search algorithm that can shorten search time is not limited to the above-mentioned example but various modifications are possible. The search algorithm that narrows the search range from the beginning by using a measured capacitance value and its other modifications are also applicable to an evolution voltage search.

In the case of the display apparatus according to the first embodiment, the capacitance of the display device 10 is detected by driving the display device 10 by the DDS and setting all pixels to substantially the same display state. Driving the display device 10 by the DDS involves applying the waveform as illustrated in FIG. 8 to all scan lines while shifting the application position, which takes some time. Accordingly, it is desirable to perform step S31 illustrated in FIG. 16 for all of the gray scale levels to be displayed. In the case of displaying eight levels of gray, setting of the display state is to be performed about five times for seven intermediate gray scale levels, and thus setting of the display screen takes long time.

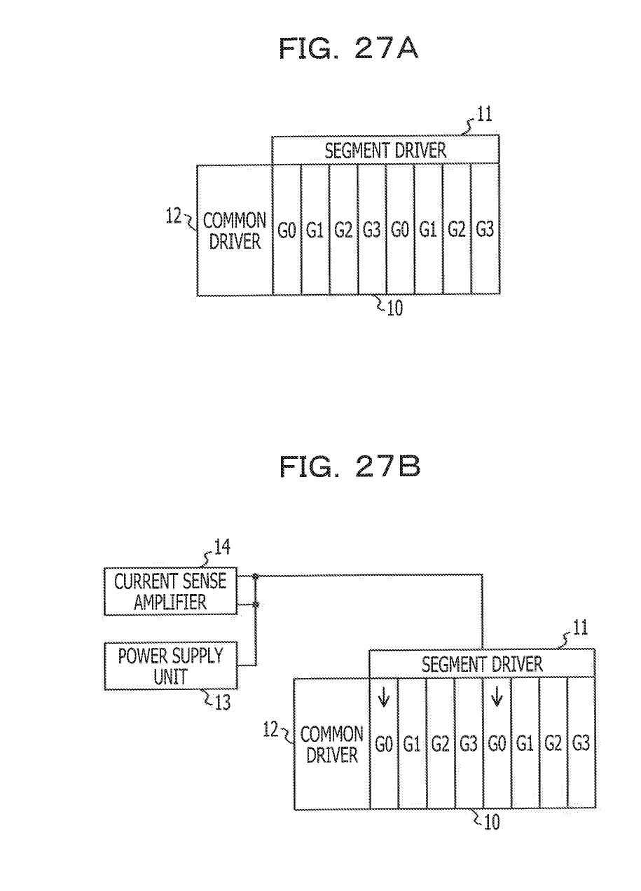

Accordingly, as illustrated in FIG. 27A, the display screen of the display device 10 is split into a plurality of regions (eight regions in FIG. 27A) corresponding to individual terminals of the segment driver 11, and regions of different levels of gray are simultaneously displayed on the display screen. In FIG. 27A, two regions are displayed in the same level of gray, and four levels of gray from G0 to G3 are displayed. Then, as illustrated in FIG. 27B, when measuring capacitance in a state in which the level of gray G0 is displayed, the segment driver 11 controls display so that a capacitance detection signal is applied only to the regions that display the level of gray G0. Subsequently, capacitance is measured in a similar manner for the levels of gray G1 to G3. As a result, the time taken to change the display state of the display device 10 can be shortened to about ¼ of that in the first embodiment.

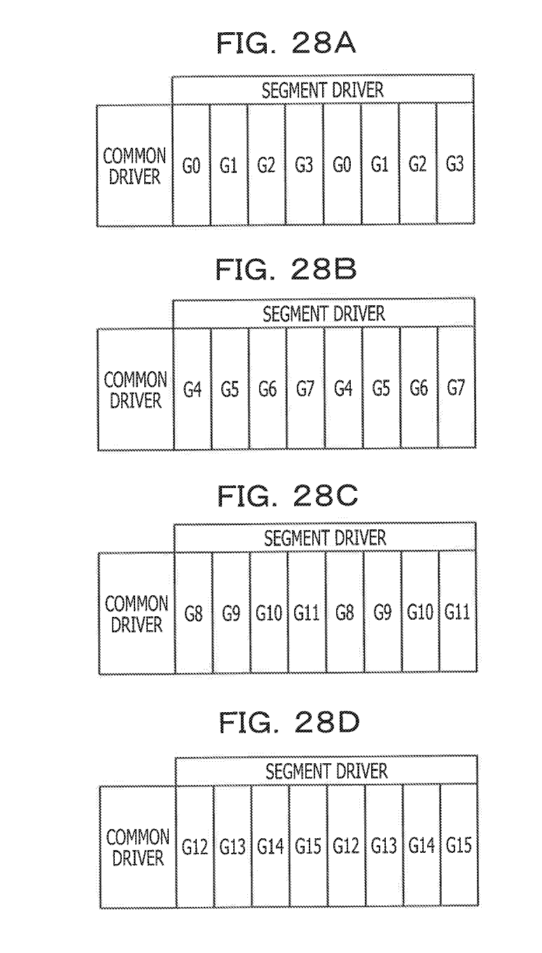

FIGS. 28A to 28D illustrate an example of display screen in a case where capacitances for 16 levels of gray from G0 to G15 are measured. In the first time, four levels of gray from G0 to G3 are displayed, and the third step S3 illustrated in FIG. 16 is iterated five times. In the second time, four levels of gray from G4 to G7 are displayed, and the third step S3 illustrated in FIG. 16 is iterated five times. Thereafter, similar operation is repeated for the levels of gray from G8 to G11 and from G12 to G15.

The reason for providing two regions that display the same level of gray within the screen in FIGS. 27A and 27B and FIGS. 28A to 28D is to remove the influence of screen unevenness.

In the case of the display apparatus according to the first embodiment, in the first step S1, the capacitances to be brought into correspondence with luminance 0 and 100 (in relative value) are determined, and in the second step S2, the evolution voltage is set so that a predetermined capacitance value for a predetermined gray scale portion is obtained from the capacitances determined in the first step S1. Then, in the third step S3, by using the evolution voltage determined in the second step S2, the relationship between the capacitance value in the gray scale portion and the duty ratio of the selection pulse is set. If, owing to the characteristics of the display device 10, the variability in terms of the luminance 0 and 100 (in relative value) and the corresponding capacitance values is small, the first step S1 can be omitted. In this case as well, if there is a variability that causes the capacitance variation characteristic with respect to the evolution voltage to shift in the horizontal direction as illustrated in FIG. 14, steps S2 and S3 are to be performed. If the variability that causes the capacitance variation characteristic with respect to the evolution voltage to shift in the horizontal direction is small, it suffices to perform only step S3 by further omitting step S2.

Conversely, if the variability in the variation of capacitance value (gray scale level) with respect to the duty ratio of the selection pulse illustrated in FIG. 21 is small, the third step S3 can be omitted.

The display apparatus according to the first embodiment is configured to obtain desired display characteristics by adjusting the evolution voltage and the duty ratio of the selection pulse. However, as previously mentioned, there are also other driving condition factors that cause the display characteristics to vary. In the case of adjusting those factors as well, the above-mentioned technique that detects the capacitance of the display device 10 in each different display state and adjusts driving conditions on the basis of the detected capacitance can be applied.

Further, while the display apparatus according to the first embodiment uses a unipolar driver IC, it is also possible to use a bipolar driver IC.

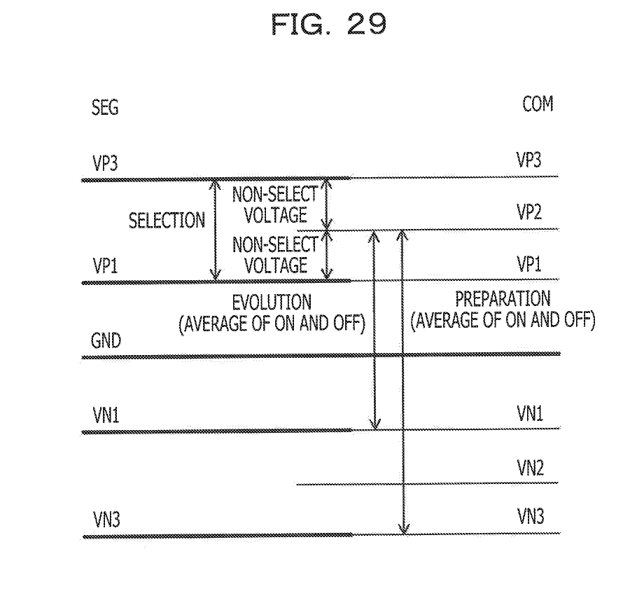

FIG. 29 illustrates the correspondence between the output voltages of the segment driver 11 and common driver 12 in the case of using a bipolar driver IC.

In this case, from the positive toward the negative side, voltages VP3, VP2, VP1, 0, VN1, VN2, and VN3 are defined from the highest to the lowest. In the positive polarity phase, when rendering an image to be displayed in white, the differential voltage between SEG-VP3 and COM-VP1 is applied in the selection period. When rendering an image to be displayed in black, the differential voltage between SEG-VP1 and COM-VP1 is applied in the selection period. In each of the preparation period and the evolution period, the average voltage is applied in accordance with the relationship illustrated in FIG. 29. In the negative polarity phase, the above-mentioned correspondence between VP and VN is reversed.

Now, the formulae for expanding to VP3, VP2, VP1, 0, VN1, VN2, and VN3 on each of the SEG and COM sides from the evolution voltage are given below. A non-select voltage is a value that represents none of the preparation/selection/evolution period, and is applied to all of rendered or unrendered pixels.

SEG_VP3=((evolution voltage)+3*non-select voltage)/2

SEG_VP2=(((evolution voltage)+3*non-select voltage)−non-select voltage)−SEG_VP3

SEG_VP1=SEG_VP3−non-select voltage*2

SEG_VN3=−(SEG_VP3)

SEG_VN2=−(SEG_VP2)

SEG_VN1=−(SEG_VP1)

COM_VP3=SEG_VP3

COM_VP2=SEG_VP2

COM_VP1=SEG_VP1

COM_VN3=−(COM_VP3)

COM_VN2=−(COM_VP2)

COM_VN1=−(COM_VP1)

In the first embodiment, capacitance values (C0′ and C100′) are measured, and if the difference between each measured capacitance value and a pre-stored capacitance measured in the previous automatic driving-condition adjustment process is large, the automatic driving-condition adjustment process is performed again, and if the difference is small, part of the automatic driving-condition adjustment process, for example, setting of the evolution voltage is omitted. However, if the difference between the measured capacitance value and the pre-stored capacitance measured in the previous automatic driving-condition adjustment process is sufficiently small, the change in panel characteristics is small, and in many cases the evolution voltage and the Duty ratio of PWM may not be changed. In such cases, the evolution voltage and the Duty ratio of PWM may not be changed, in other words, the automatic driving-condition adjustment process may not be performed.

A display apparatus according to a second embodiment described next has substantially the same hardware configuration as that of the display apparatus according to the first embodiment. The only difference is that the display apparatus according to the second embodiment is configured to determine whether or not to initiate the second and subsequent iterations of the automatic driving-condition adjustment process.

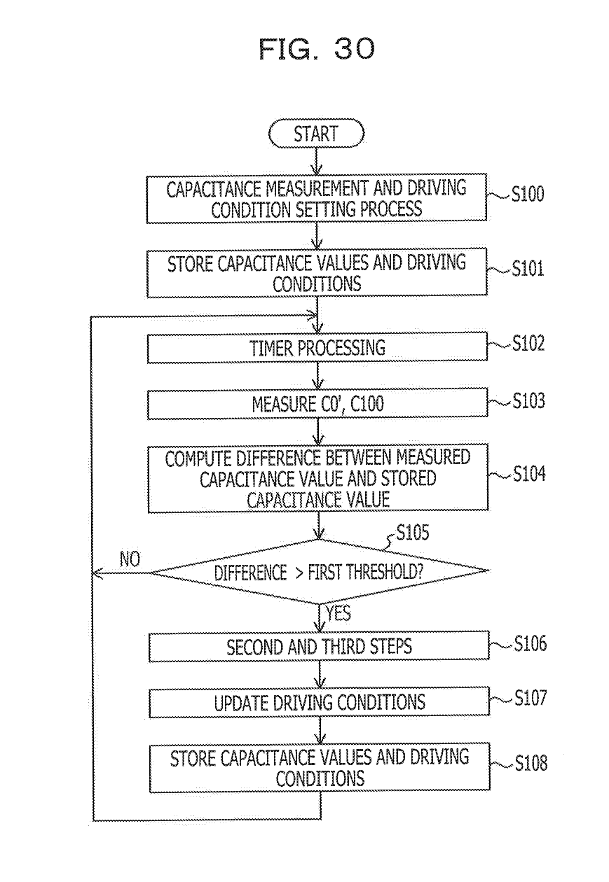

FIG. 30 is a flowchart illustrating an automatic adjustment process for driving conditions in the display apparatus according to the second embodiment.

In step S100, the automatic driving-condition adjustment process illustrated in FIG. 16 is performed at least once. That is, capacitances corresponding to the white display and the black display are measured, and the evolution voltage and the duty ratio of the selection pulse that provides a target capacitance value are determined.

In step S101, the controller 23 stores the capacitances (C0 and C100′) measured in the previous automatic driving-condition adjustment process, and the evolution voltage and the duty ratio of the selection pulse that have been set, into a memory (not illustrated).

In the second embodiment, in order to vary driving conditions in accordance with aging and environmental changes, the automatic driving-condition adjustment process is activated periodically.

Accordingly, in step S102, timer processing is performed to detect elapse of a predetermined period of time. It is also possible to activate the automatic driving-condition adjustment process on the basis of not only timer processing but also other factors such as temperature changes, or combination of those factors. It is also possible to receive an activation signal for the automatic driving-condition adjustment process from the outside.

In step S103, substantially the same processing as step S6 in FIG. 24 is performed. As a result, capacitance values C0′ and C100′ respectively corresponding to the 0% point and the 100% point are measured.

In step S104, differences D0 and D100 between the capacitance values C0′ and C100′ measured in step S103, and the previous capacitance values stored in step S101 are measured, respectively. Symbol D0 denotes the absolute value of the difference between the capacitance value C0′ measured in step S103 and the capacitance value C0′ stored in step S101. Symbol D100 denotes the absolute value of the difference between the capacitance value C100′ measured in step S103 and the capacitance value C100′ stored in step S101.

In step S105, it is determined whether or not each of the differences is larger than a first threshold. The processing proceeds to step S106 if the difference is larger than the first threshold, and returns to step S102 if the difference is smaller than the first threshold. When the processing returns to step S102, the state up to that point is maintained until an activation signal is generated next. In other words, the automatic driving-condition adjustment process is not performed. As mentioned above, when the changes of the capacitance values C0′ and C100′ are sufficiently small, the change in panel characteristics is small, and thus the evolution voltage and the Duty ratio of PWM may not be changed. Therefore, there is no problem with not performing the automatic driving-condition adjustment process.

In step S106, the second step S2 and the third step S3 illustrated in FIG. 16 are performed to set the evolution voltage and the Duty ratio of PWM. At this time, it is possible to perform the process for shortening processing time described above with reference to the first embodiment.

In step S107, drive conditions are updated to the driving conditions that have been set.

In step S108, the capacitance values C0 and C100′ measured in step S103, and the updated driving conditions such as the evolution voltage and the Duty ratio of PWM are stored, and the processing returns to step S102.

While the display apparatus according to the first embodiment employs the DDS, the above-mentioned technique that detects the capacitance of the display device 10 in each different display state and adjusts driving conditions on the basis of the detected capacitance is also applicable to cases where the aforementioned conventional driving scheme is employed. Hereinafter, a display apparatus according to a third embodiment which employs the conventional driving scheme is described.

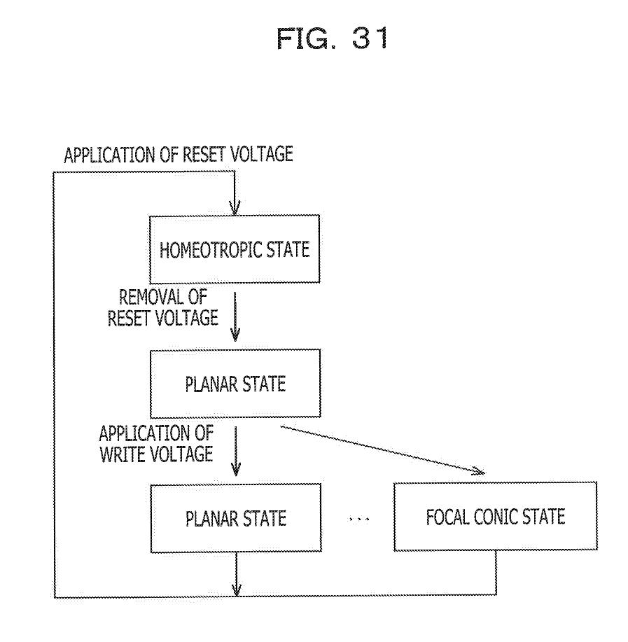

FIG. 31 illustrates changes in the display state of the display apparatus according to the third embodiment.

A cholesteric liquid crystal assumes the homeotropic state upon application of a strong electric field (reset voltage). In the homeotropic state, the liquid crystal molecules all align in the direction of the applied electric field. Rapidly removing the electric field application in the homeotropic state switches the cholesteric liquid crystal to the planar state. Application of a medium electric field (write voltage) in the planar state causes the cholesteric liquid crystal to change from the planar state to the focal conic state. However, the ratio of the liquid crystal molecules that change to the focal conic state varies with the application time. Specifically, a short the application time results in a small ratio of the focal conic state, and a long application time results in a large ratio of the focal conic state.

The conventional driving scheme enables display of gray scale levels with high uniformity which is difficult to achieve with the DDS. As such, the conventional driving scheme is useful when it is desired to produce a display that is close to full color.

The display apparatus according to the third embodiment has substantially the same configuration as that illustrated in FIG. 1. The display apparatus according to the third embodiment uses the segment driver 11 and the common driver 12 used for the passive matrix addressing, and differs from the first embodiment in that the driving scheme employed is the conventional driving scheme. Since there is a wide range of existing display apparatuses using cholesteric liquid crystals employing the conventional driving scheme, a detailed description in this regard is omitted. Hereinafter, only relevant features are briefly described.

The conventional driving scheme includes a reset process and a write process. In the reset process, a reset voltage is applied to all the pixels to be rewritten to drive the pixels to the homeotropic state, and then the application of the reset voltage is removed to drive the pixels to the planar state. In the write process, a write pulse is applied to each pixel, and the application time of the write pulse is adjusted to display an image.

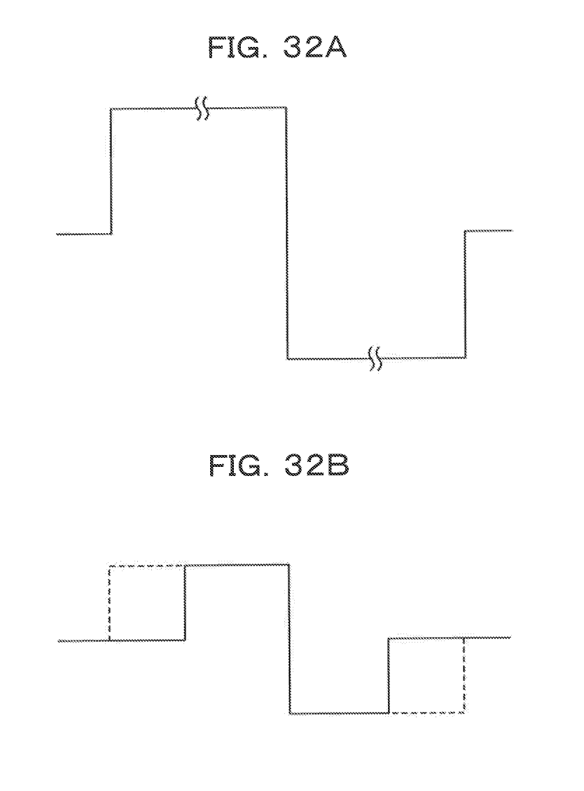

FIG. 32A illustrates a reset pulse applied to all pixels during the reset process. The reset pulse is, for example, a pulse of ±36V with a width of several tens ms.

As mentioned above, the mixing ratio of the focal conic state varies with the application time of a write voltage. The method of changing the application time of a write voltage can be roughly divided into two methods. A first method is to change the application time by the pulse width. A second method is to cause short pulses to be accumulated, and change the application time by the number of accumulated pulses.

FIG. 32B illustrates a write pulse in the case of executing the first method. The write pulse is a pulse of ±20V with varying pulse width. Specifically, the common driver 12 applies a scan pulse to each scan line, and shifts the position of the scan line to which to apply the scan pulse line by line. The period of the scan pulse applied to one line is the maximum pulse width of the write pulse. In synchronization with the application of the scan pulse, the segment driver 11 applies a signal for controlling ON/OFF of the write pulse. As a result, all the pixels in one scan line to which to apply the scan pulse are written. The scan pulse is not applied to the pixels to be maintained in the planar state (white display). For the pixels to be driven to the focal conic state (black display), a scan pulse with a width corresponding to the period of the scan pulse is applied. For the pixels to be displayed in gray scale, a scan pulse with a pulse width that varies with the corresponding level of gray is applied.

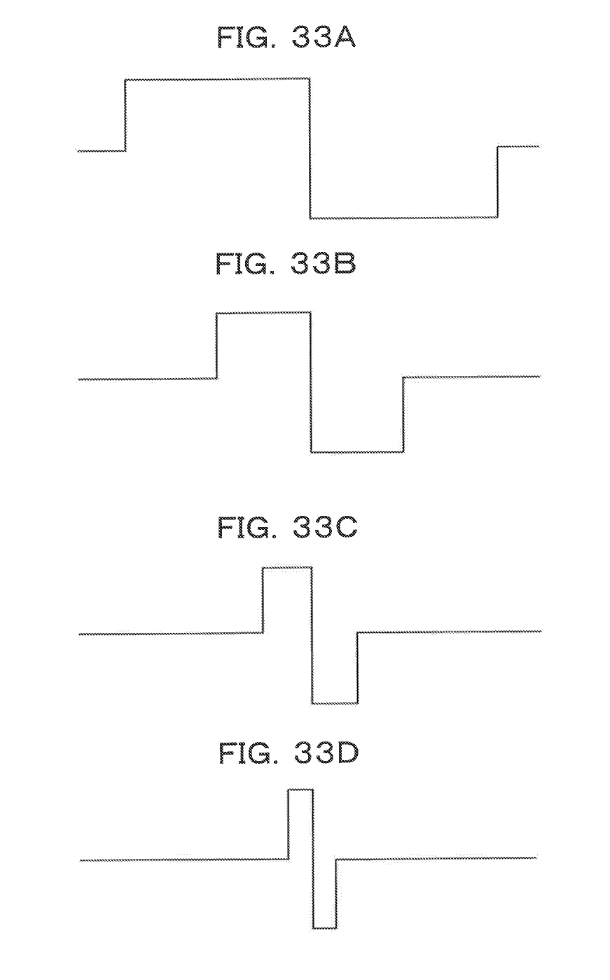

FIGS. 33A to 33D illustrate write pulses in the case of executing the second method. The pulses in FIGS. 33A to 33D are applied over four frames. The write pulses in FIGS. 33A to 33D successively halve in width. In the first frame, the common driver 12 applies a scan pulse corresponding to the write pulse illustrated in FIG. 32A to each scan line, and shifts the position of the scan line to which to apply the scan pulse line by line. In synchronization with the application of the scan pulse, the segment driver 11 applies a signal for controlling ON/OFF of the write pulse. Thereafter, likewise, the write pulses in FIGS. 33B to 33D are applied. A write pulse of a width 8 is applied to pixels with only the write pulse in FIG. 33A being ON, and a write pulse of a width 4 is applied to pixels with only the write pulse in FIG. 33B being ON. Thereafter, a write pulse is applied in a similar manner. Therefore, a write pulse with the maximum width of 15 is applied to pixels with all the write pulses in FIGS. 33A to 33D being ON, and no write pulse is applied to pixels with all of those write pulses being OFF.

In the display apparatus according to the third embodiment, the parameters to be adjusted for driving conditions include, for example, the voltage of a write pulse in the write process, the maximum accumulated time of write pulses, and pulse width. These parameters are optimized by the Newton's method, the bisection method, or the like while measuring the capacitance of the display device 10 for which a display state has been set.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display apparatus comprising:
a display device that has a memory property to maintain its display state even after a drive applied to the display device is removed;
a detection circuit configured to detect a capacitance exhibited by the display device;
an adjustment circuit configured to make an adjustment of a driving condition for the display device, based on the capacitance of the display device detected by the detection circuit when the display device is in a display state that is set by driving the display device under a predetermined driving condition; and
a storing circuit configured to store a capacitance of the display device and a driving condition for the display device that are used in a previous adjustment,
wherein the adjustment circuit changes an adjustment sequence in accordance with a difference between the capacitance detected by the detection circuit, and the capacitance stored in the storing circuit.

2. The display apparatus according to claim 1, wherein:
the adjustment circuit omits part of the adjustment sequence when the difference is small.

3. The display apparatus according to claim 1, wherein:
the display device uses a cholesteric liquid crystal.

4. The display apparatus according to claim 3, wherein:
the display device is driven by a dynamic driving scheme (DDS).

5. The display apparatus according to claim 4, wherein:
the adjustment circuit adjusts the driving condition by adjusting a voltage value in an evolution period as a parameter, and adjusts the driving condition by adjusting a duty ratio in a selection period as a parameter on condition that the adjusted voltage value be used.

6. The display apparatus according to claim 5, wherein:
the adjustment circuit adjusts each of the voltage value in the evolution period and the duty ratio in the selection period by a bisection method.

7. The display apparatus according to claim 6, wherein:
the adjustment circuit makes the adjustment so that the capacitance measured while varying the duty ratio in the selection period becomes closer to a target capacitance, and terminates the adjustment when a difference between the measured capacitance and the target capacitance becomes less than or equal to ±100/2(N−1) in a case where N levels of gray are to be displayed.

8. The display apparatus according to claim 1, wherein:
the adjustment circuit adjusts the driving condition for the display device based on the capacitance detected in each of at least two different display states.

9. The display apparatus according to claim 1, wherein:
the detection circuit includes
a current detection waveform applying circuit configured to generate a signal having a current detection waveform and apply the current detection waveform to the display device, and
a current detecting circuit configured to detect a current value applied to the display device when the signal having the current detection waveform is applied.

10. The display apparatus according to claim 9, wherein:
the current detection waveform is a sawtooth or triangular wave.

11. The display apparatus according to claim 10, further comprising:
a segment driver configured to drive the display device by a passive matrix addressing,
wherein the current detecting circuit is placed so as to measure a current supplied to the segment driver.

12. The display apparatus according to claim 1, wherein:
the detection circuit detects the capacitance by setting an entire surface of the display device to a predetermined display state and applying a signal having a current detection waveform to the display device.

13. The display apparatus according to claim 11, wherein:
the detection circuit detects the capacitance by dividing a display surface of the display device into regions each corresponding to an output terminal of the segment driver, setting each of the regions of the display surface of the display device to a predetermined display state, and applying the signal having the current detection waveform to each of the regions.

14. The display apparatus according to claim 9, wherein:
the adjustment circuit includes
an A/D converter configured to convert the current value detected by the current detecting circuit into a digital value, and
a computing circuit configured to compute the driving condition based on the digital value outputted by the A/D converter.

15. The display apparatus according to claim 1, wherein:
the display device includes a laminated structure of a plurality of liquid crystal layers that each exhibit different reflected light, and
the adjustment circuit adjusts the driving condition separately for each of the liquid crystal layers.

16. A display apparatus comprising:
a display device that has a memory property to maintain its display state even after a drive applied to the display device is removed;
a detection circuit configured to detect a capacitance exhibited by the display device;
an adjustment circuit configured to make an adjustment of a driving condition for the display device, based on the capacitance of the display device detected by the detection circuit when the display device is in a display state that is set by driving the display device under a predetermined driving condition; and
a storing circuit configured to store a capacitance of the display device and a driving condition for the display device that are used in a previous adjustment,
wherein the detection circuit detects the capacitance periodically, and the adjustment circuit executes the adjustment when a difference between the capacitance detected by the detection circuit and the capacitance stored in the storing circuit is more than or equal to a predetermined value.

17. A drive control method for a display device, the display device having a memory property to maintain its display state even after a drive applied to the display device is removed, comprising:
storing a capacitance of the display device and a driving condition for the display device that are used in a previous adjustment;
detecting a capacitance exhibited by the display device in a display state that is set by driving the display device under a predetermined driving condition; and
adjusting the driving condition for the display device based on the detected capacitance, and changing an adjustment sequence based on a difference between the detected capacitance and the stored capacitance.

18. The drive control method for a display device according to claim 17, wherein:
when the difference is small, part of the adjustment sequence for the driving condition is omitted.

19. A drive control method for a display device, the display device having a memory property to maintain its display state even after a drive applied to the display device is removed, comprising:
storing a capacitance of the display device and a driving condition for the display device that are used in a previous adjustment;
detecting a capacitance exhibited by the display device in a display state that is set by driving the display device under a predetermined driving condition; and
performing the detecting of the capacitance periodically, and adjusting the driving condition for the display device based on the detected capacitance value when a difference between the detected capacitance and the stored capacitance is more than or equal to a predetermined value.
